(19) United States
(12) Patent Application Publication
(10) Pub. No.: US 2012/0297341 A1
(43) Pub. Date: Nov. 22, 2012

(54) Modified Operating Systems Allowing Mobile Devices To Accommodate IO Devices More Convenient Than Their Own Inherent IO Devices And Methods For Generating Such Systems

(75) Inventors: Joshua Glazer, Raanana (IL); Matan Shapira, Tel-Aviv (IL); Gilad Yehiel Ben-Yossef, Rishon Le Zion (IL)

(73) Assignee: SCREENOVATE TECHNOLOGIES LTD., Raanana (IL)

(21) Appl. No.: 13/576,218

(22) PCT Filed: Feb. 16, 2011
(86) PCT No.: PCT/IL11/00163

§ 371 Date: Aug. 1, 2012

Related U.S. Application Data
(60) Provisional application No. 61/304,955, filed on Feb. 16, 2010.

(51) Int. Cl. G06F 3/048; G06F 13/14

(52) U.S. Cl. 715/810; 710/8; 715/764; 715/856

(57) ABSTRACT

A computerized system for hopping between an existing population of I/O devices, each I/O device being operative to communicate with operating systems in accordance with a respective I/O protocol, the system comprising a mobile operating system operative to execute at least one application by communicating with a selectable individual one of the existing population of I/O devices, including selectably interacting with the selectable individual I/O device in accordance with its respective I/O protocol, wherein the population of I/O devices from which the individual I/O device is selected includes a plurality of I/O devices including at least one I/O device which is not housed with the operating system; and hardware within which the mobile operating system resides and interacting with the mobile operating system.

### REFERENCE TO CO-PENDING APPLICATIONS

Priority is claimed from U.S. Provisional Patent Application No. 61/304,955, entitled “Apparatus and Methods For UI Conversion Such As Modification Of Touch-Based Operating Systems” and filed 16 Feb. 2010.

### FIELD OF THE INVENTION

The present invention relates generally to operating systems and more particularly to operating systems for mobile electronic devices.

### BACKGROUND OF THE INVENTION

Laptops today can use either their own keyboard, which uses a first protocol, or Wireless e.g. Bluetooth non-inherent keyboard which use a different protocol. There are today touch-based Tablets almost as small as smart phones which have 2 selectable keyboards with different protocols. There are today touch-based Tablets almost as small as smart phones which have 2 selectable screens with different protocols, one inherent and one external e.g. via cable. Laptop computers today know how to talk to a screen which is not inherent to them.

Microsoft Windows 7 supports touch operations when using touch screens on the device running Windows 7, and supports screens and input devices not inherent to the device running it.

Asus Eee Slate EP121 is a tablet running Windows 7 which supports use of an external screen through HDMI and external mouse and keyboard using USB and Bluetooth.

According to Wikipedia, Android is a mobile operating system initially developed by Android Inc. Android was bought by Google in 2005. Unit sales for Android OS smartphones ranked first among all smartphone OS handsets sold in the U.S. in the second and third quarters of 2010. Android has a large community of developers writing application programs (“apps”) that extend the functionality of the devices. There are currently over 200,000 apps available for Android.

The Android operating system software stack comprises of Java applications running on a Java-based, object-oriented application framework on top of Java core libraries running on a Dalvik virtual machine featuring JIT compilation. Libraries written in C include the surface manager, OpenCore[18] media framework, SQLite relational database management system, OpenGL ES 2.0 3D graphics API, WebKit layout engine, SGL graphics engine, SSL, and Bionic libc.

A state of the art Android based system is described on the World Wide Web at android-x86.org. The Oxdroid project is described at the following http link: code.google.com/p/Oxdroid.

A selection method that automatically detects a target layout and changes to an appropriate mode using the concept of an activation area in a touch screen device, is described in Sunghyuk Kwon et al, “Two-Mode Target Selection: Considering Target Layouts In Small Touch Screen Devices”, International Journal Of Industrial Egonomics 40 (2010), 733-745.

Published United States Patent Application 20030046401 to Abbott, entitled “Dynamically determining appropriate computer user interfaces” describes a method, system, and computer-readable medium for dynamically determining an appropriate user interface (“UI”) to be provided to a user including dynamically modify a UI being provided to a user of a wearable computing device so that the current UI is appropriate for a current context of the user. In order to dynamically determine an appropriate UI, various types of UI application-specific needs may be characterized (e.g., based on a current user's situation, a current task being performed, current I/O devices that are available, etc.) in order to determine characteristics of a UI that is currently optimal or appropriate, various existing UI designs or templates may be characterized in order to identify situations for which they are optimal or appropriate, and one of the existing UIs that is most appropriate may then be selected based on the current UI application-specific needs.

The disclosures of all publications and patent documents mentioned in the specification, and of the publications and patent documents cited therein directly or indirectly, are hereby incorporated by reference.

### SUMMARY OF THE INVENTION

Certain embodiments of the present invention seek to provide a method for operating a mobile smart telephone, netbook, tablet or other electronic device housing an OS, the method comprising: modifying the electronic device's operating system OS and providing UI (user interface) features to accommodate a large IO device such as a laptop screen or keyboard.

Certain embodiments of the present invention seek to provide a method for modifying an existing touch based OS in such way which will allow using the subject OS with its existing apps, with new, previously unsupported HIDs, output devices and use cases, in a more optimized manner, typically without requiring modification to existing apps.

The subject operating system may optionally have some or all of the characteristics of the Android operating system, e.g. may conform to all of or any subset of the following technical description:

Handset layouts: The platform is adaptable to larger, VGA, 2D graphics library, 3D graphics library based on OpenGL ES 2.0 specifications, and traditional smartphone layouts.

Storage: SQLite, a lightweight relational database, is used for data storage purposes Connectivity Android supports connectivity technologies including GSM/EDGE, IDEN, CDMA, EV-DO, UMTS, Bluetooth, Wi-Fi, LTE, and WiMAX.

Messaging: SMS and MMS are available forms of messaging, including threaded text messaging and now Android Cloud to Device Messaging Framework (C2DM) is also a part of Android Push Messaging service.

Web browser: based on the open-source WebKit layout engine, coupled with Chrome's V8 JavaScript engine. The browser scores a 93/100 on the Acid3 Test.

Java support: While most Android applications are written in Java, there is no Java Virtual Machine in the platform and Java byte code is not executed. Java classes are compiled into Dalvik executables and run on the Dalvik virtual machine. Dalvik is a specialized virtual machine designed specifically for Android and optimized for battery-powered mobile devices with limited memory and CPU. J2ME support may be provided via third-party applications.

Media support: Android supports the following audio/video/still media formats: WebM, H.263, H.264 (in 3GP or MP4 container), MPEG-4 SP, AMR, AMR-WB (in 3GP container), AAC, HE-AAC (in MP4 or 3GP container), MP3, MIDI, Ogg Vorbis, WAV, JPEG, PNG, GIF, BMP.

Streaming media support: RTP/RTSP streaming (3GPP PSS, ISMA), HTML progressive download (HTML5<video>tag). Adobe Flash Streaming (RTMP) and HTTP Dynamic Streaming are supported by the Flash 10.1 plugin.[67] Apple HTTP Live Streaming is supported by RealPlayer for Mobile[68] and planned to be supported by the operating system in Android 3.0 (Honeycomb). Microsoft Smooth Streaming is planned to be supported through the awaited port of Silverlight plugin to Android.

Additional hardware support: may use video/still cameras, touchscreens, GPS, accelerometers, gyroscopes, magnetometers, proximity and pressure sensors, thermometers, accelerated 2D bit blits (with hardware orientation, scaling, pixel format conversion) and accelerated 3D graphics.

Development environment” includes a device emulator, tools for debugging, memory and performance profiling. The integrated development environment (IDE) is Eclipse (currently 3.4 or greater) using the Android Development Tools (ADT) Plugin. The programming languages are Java and C/C++.

Market: The Android Market is a catalog of applications that may be downloaded and installed to Android devices over-the-air, without the use of a PC.

Multi-touch: Android has native support for multi-touch which was initially made available in handsets such as the HTC Hero. The feature was originally disabled at the kernel level (possibly to avoid infringing Apple's patents on touch-screen technology). Google has since released an update for the Nexus One and the Motorola Droid which enables multi-touch natively.

Bluetooth: Supports A2DP, AVRCP, sending files (OPP), accessing the phone book (PBAP), voice dialing and sending contacts between phones. Keyboard, mouse and joystick (HID) support is available through manufacturer customizations and third-party applications. Full HID support is planned for Android 3.0 (Honeycomb).

Video calling: The mainstream Android version does not support video calling, but some handsets have a customized version of the operating system which supports it, either via UMTS network (like the Samsung Galaxy S) or over IP. Video calling through Google Talk is planned for Android 3.0 (Honeycomb).

Multitasking: Multitasking of applications is available.

Voice based features: Google search through Voice has been available since initial release.

Voice actions for calling, texting, navigation etc. are supported on Android 2.2 onwards.

Tethering: Android supports tethering, which allows a phone to be used as a wireless/wired hotspot.

The following terms may be construed either in accordance with any definition thereof appearing in the prior art literature or in accordance with the specification, or as follows:

perform I/O: to perform an input or output operation.

I/O devices: Devices used by a person (or other system) to communicate with a computer. For instance, a keyboard or a mouse may be an input device for a computer, while monitors and printers are considered output devices for a computer.

I/O device which is not inherent to the mobile processor: I/O device which is not housed with the mobile processor hence does not move together with the mobile processor and has a different protocol than the I/O device if any are housed with the mobile processor.

Configuration change event handler: an event handler of a system event which notifies about Configuration changes, for example, in Android OS: android.app.Activity.onConfigurationChanged method.

Global configuration object: a software object which holds and provides data about a current system configuration. For example: has a keyboard, screen orientation, etc.

Base text viewing and editing UI control: a UI control which is the base class for the UI controls which enable core text viewing and editing functionality, or those classes themselves if such base class does not exist.

Cursor based UIs: UIs which use a mouse cursor

Virtual button or “virtual key”: a button which is operated through the phone's/device's touch interface and is not displayed in a mobile phone's (or other electronic e.g. digital device's) screen, instead usually being displayed above or under the screen.

Actual button: a button operated by physical manipulation on the part of a user (such as but not limited to a mobile phone on/off switch).

Physical button: virtual button (virtual key) or actual button.

Software button: (sometimes known as a command button or push button) According to Wikipedia, a user interface element that provides the user a simple way to trigger an event, e.g. searching for a query at a search engine, or to interact with dialog boxes, like confirming an action.

Use case: the manner which the device is used and the setup of that use. For example, using a phone or other electronic device, in conjunction with a big screen and a mouse while sitting next to a desk.

Touch pad emulation: using the touchscreen of the device running the subject OS as if it were a standard touch pad.

Highlighting: making a UI control to change its appearance in order to appear differently than the other ones

Cursor: a mouse cursor

Basic dispatching: dispatching of events from a driver to an OS (operating system)

Relative input events/relative position: events/position which represents a relative change in current coordinates. For example, increasing the current x coordinate by 45.

Focusable: a UI control which may be focused

UI element: a visual UI control, or a set of those which provides a certain functionality, such as but not limited to any of the following: task bar, window, button, text editing box (text box), drop down list (combo box), text, image, table, list, tab, radio button, html viewer, tool bar, menu,

Special keys: keys on a computer keyboard which are used for actions and not for typing a character. For example, the keys: “Windows”, “Menu”, “Home”, “Alt”.

Existing apps: any application, service, widget, or web application which can run on an existing OS.

HID: Human Interface Device used for input, such as but not limited to mouse, touchpad, trackball, keyboard, remote control, keypad, joystick, game pad and touch screen.

IO Devices: HIDs and display output devices

Display Output Devices: including but not being limited to: PC screen, laptop screen, tablet touchscreen, phone touchscreen, car integrated touch screen, TV.

Productivity use case: a use case in which a cursor based HID is connected and a large, high resolution screen is used such as a full-size desktop computer screen.

Context aware cursor: A cursor pointing to computer screen content, the cursor including an icon having at least one characteristic such as size or shape or color which changes responsive to at least one detected characteristic of computer screen content. For example, in Mozilla Firefox when the mouse cursor is located over a link, the mouse cursor may change its shape to a hand. Or, a cursor pointing to text may have a first shape, whereas a cursor pointing to screen content other than text may not have that shape.

Hot Spot: a spot in the cursor's image matching the mouse coordinates on the screen. For example, for a pointer (arrow) mouse cursor, the end of the arrow; for a hand cursor, the top of the index finger.

Cursor Type: typically includes an image and a hot spot coordinate for this image. Conventional types are pointer (diagonal arrow pointing top-left) and hand cursor (a hand with the index finger pointing up).

Touch Based OS or Touch OS: An operating system which supports a touch screen having at least the following characteristics:
a. most buttons are large enough and/or far enough apart to be easily finger-operable;
b. finger-controlled scrolling capability.
and optionally having one or more of the following characteristics:
aa. supports at least one finger gesture other than finger-controlled scrolling and pressing such as xxx
bb. most buttons are large enough and/or far enough apart to be easily finger-operable;

Examples of touch-based operating system include Windows Mobile, Blackberry OS, Windows 7, iOS, Meeboo, Android, Symbian.

Optionally, a Touch Based OS or Touch OS as used herein may refer to an operating system that enables input mechanism through touch on a screen and/or has less than full mouse and keyboard functionality, such as Windows Mobile, Blackberry OS, Windows 7, iOS, Meeboo, Android, Symbian. Typically the UI elements of such OS are large enough to facilitate easy finger-operated use of the touchscreen. Typically, the GUI supports touch based gestures. According to one embodiment, the touch OS does not support any of the following i.e. supports none of the following features: context aware cursor, cursor based HID text selection, scrolling using a device which is not housed integrally with the electronic device in which the OS resides, PC oriented key combinations, use of a secondary button of a cursor based HID. According to another embodiment, the touch OS supports less than all of the above features; or supports only one of the above features, or supports only a particular pair of the 10 possible pairs of features above, or supports all of the above features but for one, or supports all of the above features but for a particular pair from among the 10 possible pairs of features above.

Touch Based Gestures: pinching, swiping and more generally any user gesture supported by a touch screen which includes a group of one or more possibly simultaneous (multi-touch) screen-touches and drags over the touch screen and is more complex than simple binary touch/not touch of a touch screen.

PC oriented key combinations: Alt+Tab, Alt+Ctrl+Delete, Ctrl+c, Ctrl+v and more generally any combination of keys on a keyboard which triggers a computerized action other than displaying a symbol e.g. alphanumeric character on a display screen.

PC oriented special keys: Windows key, menu key, home key, page down key and more generally any key on a keyboard which triggers a computerized action other than displaying a symbol e.g. alphanumeric character on a display screen.

Secondary Button Of A Cursor Based HID: an input option other than the main input option of a cursor-based HID such as the right-button of a mouse which may be used, e.g. to open a context menu or the middle button of a mouse which may be used to paste text from the clipboard.

Existing OS: A touch based OS, typically but not necessarily on a mobile device, such as but not limited to Android, which may be modified in accordance with any of the teachings of the present invention,

Subject OS: Also termed herein “modified OS”. Any suitable OS, e.g. an operating system such as but not limited to Android that: a. supports a touch based user interface, and/or b. does not support a cursor based user interface; wherein the operating system is modified by any or all of the teachings shown and described herein e.g. as per one or more of the modifications shown and described hereinbelow, which enable the OS to “piggy back” on a succession of IO devices which are typically larger than pocket-size hence more convenient, typically including at least one external display i.e. display which is not always connected to the receptacle housing the subject operating system.

Surface: a class that is used for painting computer graphics to the screen and accessing display/video memory. The class contains a matrix of pixels that are intended to be drawn to the screen. A surface class enables painting over it, which means changing the matrix of pixels. Examples: Android OS Surface class, Microsoft Microsoft.WindowsMobile.DirectX.Direct3D.Surface class.

Base UI Control: a class that every UI control inherits from, directly or indirectly. The class usually represents a general UI control of unknown type. The class provides the functionality which is conventional for all the UI controls in the UI library. For example Android OS View class, Microsoft .NET Control class.

Text Cursor: The cursor that appears between two letters on conventional mouse based UIs when the user presses a text in a UI control which is editable.

Base UI Control Container: a class in every UI control that functions as a container that other UI controls may inherit from. It provides conventional functionality related to managing child (contained) UI controls. A Window object is one example of such a container. Window Management Module: a module in the existing OS having responsibilities such as but not limited to so or all of: Dispatching user input to the focused window, Managing surfaces, and Managing windows.

Long Click: is an action in touch based OSs in which the user presses the touch screen without releasing for a certain amount of time which is usually longer than an average touch click (press and release). This kind of action has different logic associated with a normal click, usually the display of a context dependent menu.

There is thus provided, in accordance with certain embodiments of the present invention, a computerized system for hopping between an existing population of I/O devices, each I/O device being operative to communicate with operating systems in accordance with a respective I/O protocol, the system comprising a mobile operating system operative to execute at least one application by communicating with a selectable individual one of said existing population of I/O devices, including selectably interacting with the selectable individual I/O device in accordance with its respective I/O protocol, wherein the population of I/O devices from which said individual I/O device is selected includes a plurality of I/O devices including at least one I/O device which is not housed with the operating system; and hardware within which the mobile operating system resides and interacting with the mobile operating system.

It is appreciated that the hardware may optionally include associated low level functionality such as but not limited to drivers, or power control.

Further in accordance with certain embodiments of the present invention, the mobile operating system comprises at least most functionalities of Android.

The mobile operating system may in particular be Android, plus certain add-on capabilities as described herein, or may include Android with certain minor modifications, as described herein, plus optionally certain add-on capabilities as described herein.

Also provided, in accordance with certain embodiments of the present invention, is a system for selecting text displayed on a display device having a text display area, the system comprising a operating system including a touch-based text selection functionality recognizing inputs; and an input device operative, responsive to user manipulation thereof, to point to locations within the text display area, the input device including a user interface accepting user manipulations, and wherein the operating system includes a user manipulation translater translating the user manipulations into inputs recognized by the touch-based text selection functionality which, when recognized, cause the touch-based text selection functionality to select the locations.

Also provided, in accordance with certain embodiments of the present invention, is a computerized system providing a context-aware pointer to a computerized display area serving at least one Android application, the system comprising an Android operating system operative to display a hierarchy of Android views generated pursuant to the Android application, an Android view interpreter identifying, at each point in time, at least one view feature characterizing at least one of the views; and a context-aware cursor generator operative to generate, on the computerized display, a cursor having cursor characteristics which vary over time wherein, at a particular point in time, at least one of the cursor characteristics depends on the view feature identified at the particular point in time, for a location pointed to by the cursor at the point in time.

It is appreciated that operational units described herein as a single unit may in fact be implemented by units which are not necessarily co-located or integrated with one another such as for example portions of code which are not contiguous and instead exist at a plurality of locations within a larger software system. For example, the computerized system described in the previous paragraph may be implemented by the code portions described in clause a-g in the Android implementation which code portions are typically non-contiguous within an inclusive software program.

Further in accordance with certain embodiments of the present invention, the views include at least one of a geometric shape, an icon, and a set of alphanumeric characters.

Still further in accordance with certain embodiments of the present invention, the Android operating system includes a hierarchy of display generators respectively operative to generate the hierarchy of Android views and wherein the Android view interpreter is operative to obtain information from the display generators, from which information the feature is derivable.

Additionally in accordance with certain embodiments of the present invention, the view feature comprises whether or not the view includes at least one of a text, a link, button, text editing box, text box, drop down list, combo box, text, image, table, list, tab, radio button.

Further in accordance with certain embodiments of the present invention, the feature comprises a cursor characteristic which the Android application has designated to represent an individual Android view.

Additionally in accordance with certain embodiments of the present invention, the information comprises the feature itself.

Further in accordance with certain embodiments of the present invention, the Android view interpreter is operative to obtain the information by asking the display generators what view to display.

Still further in accordance with certain embodiments of the present invention, the operating system supports a touch based user interface and does not support a cursor based user interface.

It is appreciated that when a system hops between I/O devices, it is useful to have a pointer such as a cursor, rather than using touch-based input, e.g. in order to provide highly accurate location information which a finger is not able to provide or in order to have multi-mode input such as a mouse (due to its buttons) is able to provide more easily than a human finger. If a cursor is used, then a context-aware cursor is often preferable.

Further in accordance with certain embodiments of the present invention, the system is operative to provide a context-aware pointer to a computerized display area serving at least one Android application; and wherein the Android operating system is operative to display a hierarchy of Android views generated pursuant to the Android application; and wherein the mobile operating system also comprises an Android view interpreter identifying, at each point in time, at least one view feature characterizing at least one of the views; and a context-aware cursor generator operative to generate, on the computerized display, a cursor having cursor characteristics which vary over time wherein, at a particular point in time, at least one of the cursor characteristics depends on the view feature identified at the particular point in time, for a location pointed to by the cursor at the point in time.

Further in accordance with certain embodiments of the present invention, the mobile operating system generates a user interface (UI) and wherein the system also comprises a UI adapting functionality operative for obtaining information characterizing an I/O device to which the operating system has been connected and for modifying the user interface accordingly.

Still further in accordance with certain embodiments of the present invention, the UI adapting functionality is operative, when at least one individual I/O device is connected to the operating system, to add a task-bar to the user interface including at least one tool useful in conjunction with the individual I/O device.

Also in accordance with certain embodiments of the present invention, the task-bar is added if the individual I/O device is known to be larger than a threshold size.

Still further in accordance with certain embodiments of the present invention, the I/O device comprises an input device.

Also in accordance with certain embodiments of the present invention, the I/O device comprises a display device.

Further in accordance with certain embodiments of the present invention, the mobile operating system comprises a touch-based operating system operative to generate a display including at least one subregion which, if, when coming into contactwith a finger, triggers an operating system action, and wherein, if a cursor-based input device is connected to the operating system, the UI adapting functionality is operative to decrease the sub-region in size relative to the total area of the display.

Still further in accordance with certain embodiments of the present invention, the sub-region includes a button.

Additionally in accordance with certain embodiments of the present invention, the user manipulation comprises pressing a button on the input device.

Further in accordance with certain embodiments of the present invention, the user manipulation comprises dragging the input device.

Additionally in accordance with certain embodiments of the present invention, the operating system supports a plurality of I/O protocols.

Further in accordance with certain embodiments of the present invention, the operating system is operative to execute at least one application including recognizing an input device from among a plurality of known input devices including at least one input device which is not inherent to the operating system and executing the application based on interpreting at least one input from the recognized input device, including generating at least application output.

Further in accordance with certain embodiments of the present invention, the operating system is operative for recognizing an output device from among a plurality of known output devices and outputting the application output based on at least one parameter of the recognized output device.

Still further in accordance with certain embodiments of the present invention, the recognized input device is the inherent input device of the operating system.

Additionally in accordance with certain embodiments of the present invention, the system also comprises a client which receives input events and sends them to the operating system; an interface to a selectable input device type from among a plurality of input device types; an interface to a selectable output device type from among a plurality of output device types; and an adaptor to adapt the interfaces to each other.

Further in accordance with certain embodiments of the present invention, the IO device comprises a screen of a size comparable in size to a laptop screen.

Still further in accordance with certain embodiments of the present invention, the UI is operative to support at least one of keyboard input and mouse input, the UI being operative to provide one or more of:

i. hovering;
ii. Copy-Paste experience;
iii. Right click experience;
iv. Context aware cursor;
v. Text selection;
vi. Right mouse click functionality;
vii. PC oriented keyboard operation translation;
viii. Task bar;
ix. Scrolling by use of an external device;
x. Control of size and layout for mouse input.

Further in accordance with certain embodiments of the present invention, the user manipulation comprises left-pressing a left mouse button over a selection start point, moving mouse to a selection end point and releasing the button and wherein responsively, a text extending from the start point to the end point is selected by the operating system.

Still further in accordance with certain embodiments of the present invention, the 10 device comprises a PC keyboard and the modifying comprises adding support for at least one conventional PC oriented keyboard operation to the mobile operating system.

Yet further in accordance with certain embodiments of the present invention, the keyboard operations include at least one of alt+tab, ctrl+c, and ctrl+v.

Still further in accordance with certain embodiments of the present invention, the 10 device comprises an external scroll device.

Additionally in accordance with certain embodiments of the present invention, the scroll device comprises a mouse scroll wheel or a touch pad.

Further in accordance with certain embodiments of the present invention, the application comprises at least one of the following applications: Internet surfing, music, video viewing, emailing, calendar maintenance, maps, at least one Android application such as GPS or maps, and voicecalls.

Also provided, in accordance with certain embodiments of the present invention, is a system for input-device mediated scrolling, without touching a display area which is controlled by a touch-based cellular telephone operating system, the system comprising a control data injection point to a display control functionality in the touch-based operating system, the functionality being operative to display only a display area-sized portion of an image which is larger than the display area, responsive to sensed finger motions supplied via a finger-data injection point; and an input device-mediated scrolling interpreter operative, responsive to user manipulation of a scrolling functionality of the input device, to inject to the display control functionality via the control data injection point, an indication of a display area-sized portion of the image to be displayed on the display area.

Examples of touch-based cellular telephone operating systems include but are not limited to Android, Symbian, Blackberry, iOS, WindowsMobile. It is appreciated that such operating systems may of course also be useful in operating electronic devices which are not cellular telephones.

Also provided, in accordance with certain embodiments of the present invention, is a system for input-device mediated scrolling, without touching a display area which is controlled by a touch-based Android operating system, the system comprising a control data injection point to a display control functionality in the touch-based. Android operating system, the functionality being operative to display only a display area-sized portion of an image which is larger than the display area, responsive to sensed finger motions supplied via a finger-data injection point; and an input device-mediated scrolling interpreter operative, responsive to user manipulation of a scrolling functionality of the input device, to inject to the display control functionality via the control data injection point, an indication of a display area-sized portion of the image to be displayed on the display area.

Additionally in accordance with certain embodiments of the present invention, the display area is integrally formed with a mobile electronic device and wherein the input device is external to the mobile electronic device.

Further in accordance with certain embodiments of the present invention, the mobile electronic device comprises a mobile communication device.

Further in accordance with certain embodiments of the present invention, the mobile communication device comprises a cellular telephone.

Still further in accordance with certain embodiments of the present invention, the display area is integrally formed with a tablet and wherein the input device is external to the tablet.

Further in accordance with certain embodiments of the present invention, the control data injection point comprises the finger-data injection point.

Also provided, in accordance with certain embodiments of the present invention, is a system for accepting at least one keyboard input not supported by a touch-based operating system operative, responsive to touch inputs, to perform a plurality of operations, the system comprising a non-supported keyboard input processing functionality operative to receive an indication of the keyboard input and responsively to instruct the touch-based operating system to perform a subset of the plurality of operations.

Further in accordance with certain embodiments of the present invention, the keyboard input includes a simultaneously pressed plurality of keys not supported by the touch-based operating system.

For example, the simultaneously pressed plurality of keys may comprise alt and tab, in which case the Touch input in Android. OS may be a Long press on the Home button and the operation triggered may be generating a display of recent or running applications, allowing an app to be selected, and switching to the selected app.

Further in accordance with certain embodiments of the present invention, the keyboard input includes a single key not supported by the touch-based operating system.

Additionally in accordance with certain embodiments of the present invention, the touch-based operating system comprises Android.

Further in accordance with certain embodiments of the present invention, the system also comprises a touch-based operating system operative to perform the subset of operations responsive to touch inputs.

Also provided, in accordance with certain embodiments of the present invention, is browser apparatus operative in conjunction with an individual operating system, the browser apparatus comprising a self-identifier operative to send to a website, deceptive user agent information identifying at least one of: an operating system other than the individual operating system; and a browser other than the browser apparatus; and a web content engine operative, in conjunction with the operating system, to receive web content from the website and to enable a human user to interact with the web content.

It is appreciated that websites are rendered differently, during run-time, as a function of the entity surfing them e.g. whether the entity is a personal computer, cellular telephone or a tablet. The surfing entity's browser typically sends the website “user agent” information including identification of its own browser and/or operating system and/or perhaps, any other suitable characteristic of itself.

Further in accordance with certain embodiments of the present invention, the system also comprises an operating system and the deceptive user agent information is provided to the self-identifier by the operating system.

Still further in accordance with certain embodiments of the present invention, the operating system includes browser-identifying functionality and is operative to identify the browser apparatus and to provide to the self-identifier deceptive user agent information including an identification of a browser other than the browser apparatus as identified.

Additionally in accordance with certain embodiments of the present invention, the browser-identifying functionality comprises a field in memory of the operating system storing an identification of the browser apparatus.

Further in accordance with certain embodiments of the present invention, the self-identifier is determined by obtaining from the operating system an indication of at least one IO device currently connected to the operating system and subsequently including in the deceptive user agent information, information capable of eliciting from the website, content which aptly utilizes the 10 device.

If the IO device is a mouse and a large screen, then in order to cause the website to provide content which is adjusted for use with such PC like IO device, the following deceptive user-agent may be sent to mimic a browser running on a Windows 7 PC: Mozilla/5.0 (Windows NT 6.1; WOW64; rv:2.0b7) Gecko/20101111 Firefox/4.0b7. If the output device is a TV screen, the following deceptive user-agent/s may be sent to mimic a TV set top box and cause the website to provide content which is adjusted for TVs: Mozilla/5.0 (X11; U: Linux i686; en-US) AppleWebKit/533.4 (KHTML, like Gecko) Chrome/5.0.375.127 Large Screen Safari/533.4 GoogleTV/b39389.

Also provided in accordance with certain embodiments of the present invention, is a method for using an operating system to highlight a hovered upon portion of a computerized display area, the method comprising identifying a location within the computerized display area over which a cursor is hovering; identifying a focussable portion of the display area which includes the location; and using the operating system's focus functionality to change at least one graphic characteristic of said focussable portion.

Additionally in accordance with certain embodiments of the present invention, said operating system comprises a touch-based operating system such as Android. Also provided, in accordance with certain embodiments of the present invention, is an improved operating system comprising a touch-based operating system other than Windows7, such as Android, which, given an application running on the operating system, determines at least one dimension of a display area used to display outputs of the application as a function of a resolution parameter and a density parameter defined within the operating system; and a display device adaptation functionality operative to receive an indication of a display device currently connected to said operating system and to modify at least one of said resolution parameter and density parameter accordingly.

Further in accordance with certain embodiments of the present invention, said input device comprises an individual one of the following input devices: trackball, touchpad, mouse and wherein said scrolling functionality comprises a wheel.

Still further in accordance with certain embodiments of the present invention, the system is operative for selecting text displayed on a display device having a text display area, wherein said operating system includes a touch-based text selection functionality recognizing inputs, the operating system being operative to selectably connect to an input device operative, responsive to user manipulation thereof, to point to locations within said text display area, the input device including a user interface accepting user manipulations; and wherein said operating system also includes a user manipulation translater translating said user manipulations into inputs recognized by said touch-based text selection functionality which, when recognized, cause said touch-based text selection functionality to select said locations.

Further in accordance with certain embodiments of the present invention, the system is operative for providing a context-aware pointer to a computerized display area serving at least one Android application, the operating system comprising an Android operating system operative to display a hierarchy of Android views generated pursuant to said Android application, the operating system comprising an Android view interpreter identifying, at each point in time, at least one view feature characterizing at least one of the views; and a context-aware cursor generator operative to generate, on the computerized display, a cursor having cursor characteristics which vary over time wherein, at a particular point in time, at least one of the cursor characteristics depends on the view feature identified at the particular point in time, for a location pointed to by the cursor at the point in time.

Still further in accordance with certain embodiments of the present invention, the system is operative for input-device mediated scrolling, without touching a display area which is controlled by a touch-based cellular telephone operating system, the operating system comprising a control data injection point to a display control functionality in the touch-based operating system, the functionality being operative to display only a display area-sized portion of an image which is larger than the display area, responsive to sensed finger motions supplied via a finger-data injection point; and an input device-mediated scrolling interpreter operative, responsive to user manipulation of a scrolling functionality of the input device, to inject to the display control functionality via the control data injection point, an indication of a display area-sized portion of the image to be displayed on the display area.

Also provided, in accordance with certain embodiments of the present invention, is a system which is operative for input-device mediated scrolling, without touching a display area which is controlled by a touch-based Android operating system, the operating system comprising a control data injection point to a display control functionality in the touch-based Android operating system, the functionality being operative to display only a display area-sized portion of an image which is larger than the display area, responsive to sensed finger motions supplied via a finger-data injection point; and an input device-mediated scrolling interpreter operative, responsive to user manipulation of a scrolling functionality of the input device, to inject to the display control functionality via the control data injection point, an indication of a display area-sized portion of the image to be displayed on the display area.

Further in accordance with certain embodiments of the present invention, the operating system includes a touch-based operating system operative, responsive to touch inputs, to perform a plurality of operations, the computerized system being operative for accepting at least one keyboard input not supported by the touch-based operating system, and wherein the touch-based operating system comprises a non-supported keyboard input processing functionality operative to receive an indication of the keyboard input and responsively to instruct the touch-based operating system to perform a subset of the plurality of operations.

Still further in accordance with certain embodiments of the present invention, the system also comprises Browser apparatus operative in conjunction with the individual operating system, the browser apparatus comprising a self-identifier operative to send to a website, deceptive user agent information identifying at least one of an operating system other than the individual operating system; and a browser other than the browser apparatus; and a web content engine operative, in conjunction with the operating system, to receive web content from the website and to enable a human user to interact with the web content.

Also provided, in accordance with certain embodiments of the present invention, is an improved operating system e.g. as per above, wherein the operating system includes a touch-based operating system other than Windows7 which, given an application running on the operating system, determines at least one dimension of a display area used to display outputs of the application as a function of a resolution parameter and a density parameter defined within the operating system; and wherein the operating system includes a display device adaptation functionality operative to receive an indication of a display device currently connected to the operating system and to modify at least one of the resolution parameter and density parameter accordingly.

Further in accordance with certain embodiments of the present invention, the existing population of I/O devices includes a plurality of screen displays and wherein the operating system recognizes a single screen display resolution parameter pre-defined during manufacture, and the computerized system also comprises a resolution parameter modifier operative to dynamically obtain an individual resolution value characterizing an individual screen display from among the plurality of screen displays which has dynamically become connected to theoperating system and to modify the pre-defined screen display resolution parameter to equal the individual resolution value.

Further in accordance with certain embodiments of the present invention, the cursor-based input device is selected from among the following group: a mouse, a touchpad, a trackball.

Still further in accordance with certain embodiments of the present invention, thel/O device to which the operating system has been connected includes a large screen which is larger than required by the user interface and wherein the UI adapting functionality is operative to add at least one UI element when the large screen is found to be connected to the operating system in order to more fully utilize the large screen.

Further in accordance with certain embodiments of the present invention, the UI element is selected from the following: a task bar; and a menu.

Still further in accordance with certain embodiments of the present invention, the I/O device to which the operating system has been connected includes an external device which does not house at least one physical button assumed by the mobile operating system to exist and having a function, and wherein the UI adapting functionality is operative to add to the user interface, at least one software button restoring at least a portion of the function.

Additionally in accordance with certain embodiments of the present invention, the computerized system also comprises a density modifier operative to dynamically obtain an individual density value characterizing an individual screen display from among the plurality of screen displays which has dynamically become connected to the operating system and to modify display content intended for the individual screen display accordingly.

Further in accordance with certain embodiments of the present invention, the computerized system also comprises a resolution modifier operative to dynamically obtain an individual screen resolution value characterizing an individual screen display from among the plurality of screen displays which has dynamically become connected to the operating system and to modify display content intended for the individual screen display accordingly.

Additionally in accordance with certain embodiments of the present invention, the content includes at least one of an icon, text and image and the density modifier is operative to modify a scaling factor applied to at least one of icon, text and image.

Further in accordance with certain embodiments of the present invention, the value characterizing an individual screen display is received from the connected display.

Still further in accordance with certain embodiments of the present invention, the value characterizing an individual screen display is obtained from a local table according to the resolution coming from the connected display.

Also provided is a computer program product, comprising a typically non-transitory computer usable medium or computer readable storage medium, typically tangible, having a computer readable program code embodied therein, said computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a typically non-transitory computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein may be performed by a conventional personal computer processor, workstation or other programmable device or computer or electronic computing device, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor may be employed to compute or generate information as described herein e.g. by providing one or more modules in the processor to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIG. 1A is a simplified pictorial illustration showing operation of a mobile processor hopping between IO devices according to certain embodiments of the present invention.

FIG. 1B is a simplified functional block diagram illustration showing of the apparatus of FIG. 1A, according to certain embodiments of the present invention.

FIG. 2 is a simplified flowchart illustration of steps, some or all of which may be performed to adapt a conventional operating system to support the mobile processor of FIG. 1A as it roams from IO device to IO device.

FIG. 3 is a simplified flowchart illustration for performing the secondary button support adding step 2b in FIG. 2.

FIG. 4A is a simplified flowchart illustration of a method for implementing the context aware cursor adding step 4 in FIG. 2.

FIG. 4B is a chart setting out an example implementation of cursor type processing useful in performing the context aware cursor adding step 4 in FIG. 2.

FIG. 5 is a chart setting out an example implementation of the highlighting on hovering adding step 6 in FIG. 2.

FIG. 6 is a chart setting out a method for removing highlighting from hovering according to certain embodiments of the present invention.

FIG. 7 shows mapping of pointer based HID operation to operation in the existing OS.

FIGS. 8A-8H, taken together, form a table setting out various types of mobile operating systems.

FIG. 9A is an example screenshot illustration useful in implementing certain embodiments of the present invention.

FIGS. 9B-9D are graphic components of the example screenshot of FIG. 9A.

### DETAILED DESCRIPTION OF CERTAIN EMBODIMENTS

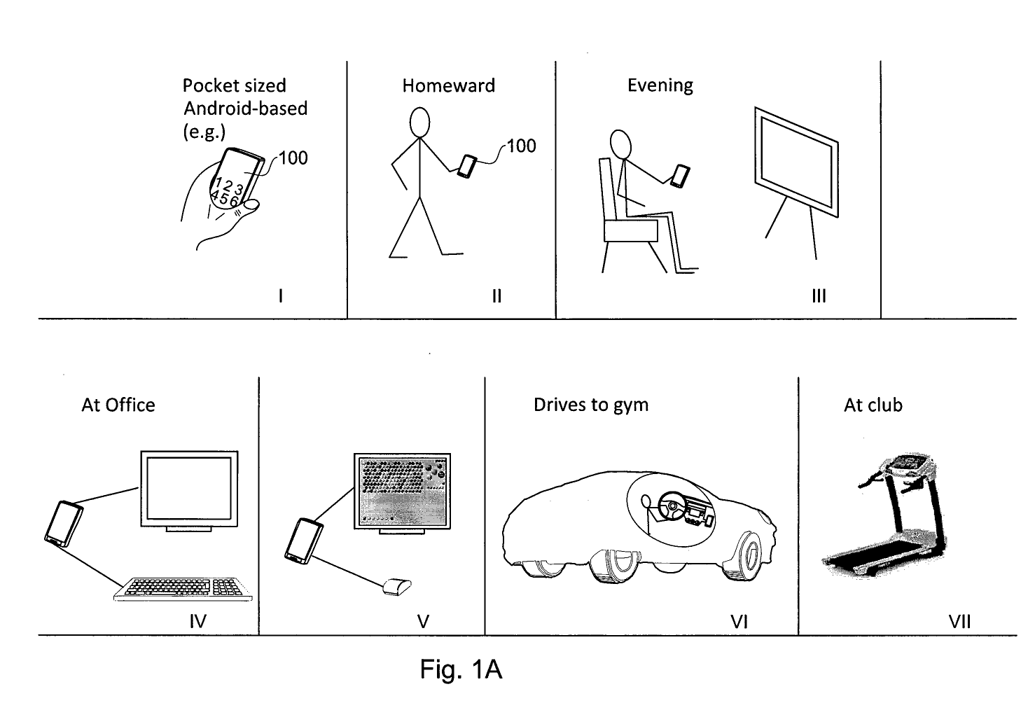

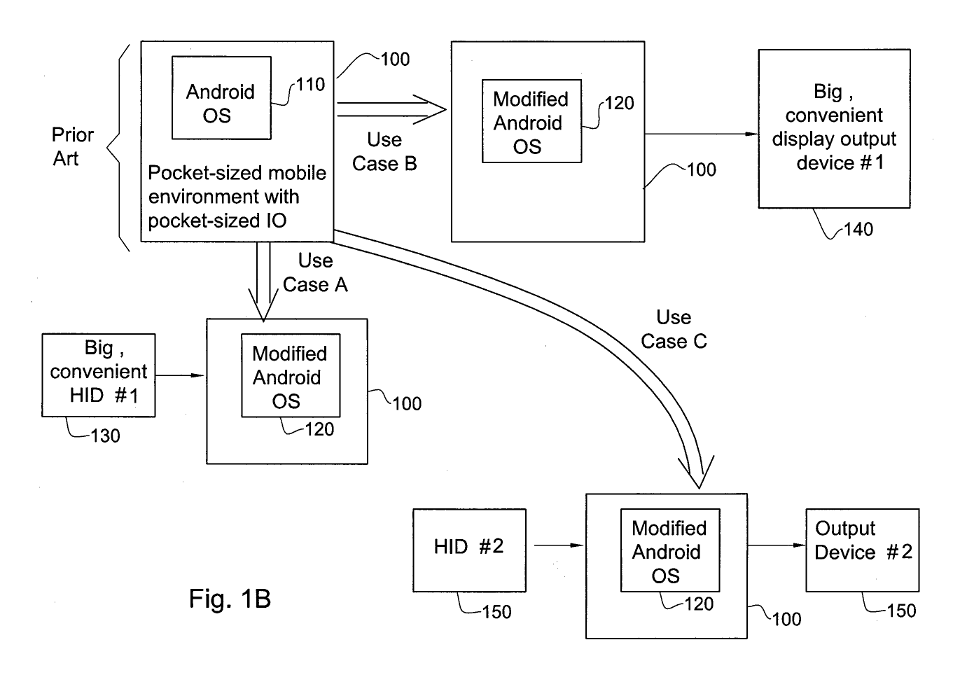

FIG. 1A is a simplified pictorial illustration showing operation of a mobile processor hopping between IO devices according to certain embodiments of the present invention. As shown, a human user wanders through his natural environment with pocket-sized mobile electronic device hardware 100 e.g. mobile phone and/or processor hardware, in which resides, and with which interacts, an operating system, possibly Android-based. The pocket sized mobile device is the center of his information-processing. Whether the user is at home, in the office, in his club or in a recreation setting, or en route to any of the above, s/he uses the mobile device, as modified by any of the teachings of the present invention, to interact with various IO devices which are larger than, hence more convenient, than the inherent IO devices of the mobile device 100 e.g. a television, full-size computer screen or keyboard, treadmill display screen, car computer screen and so forth.

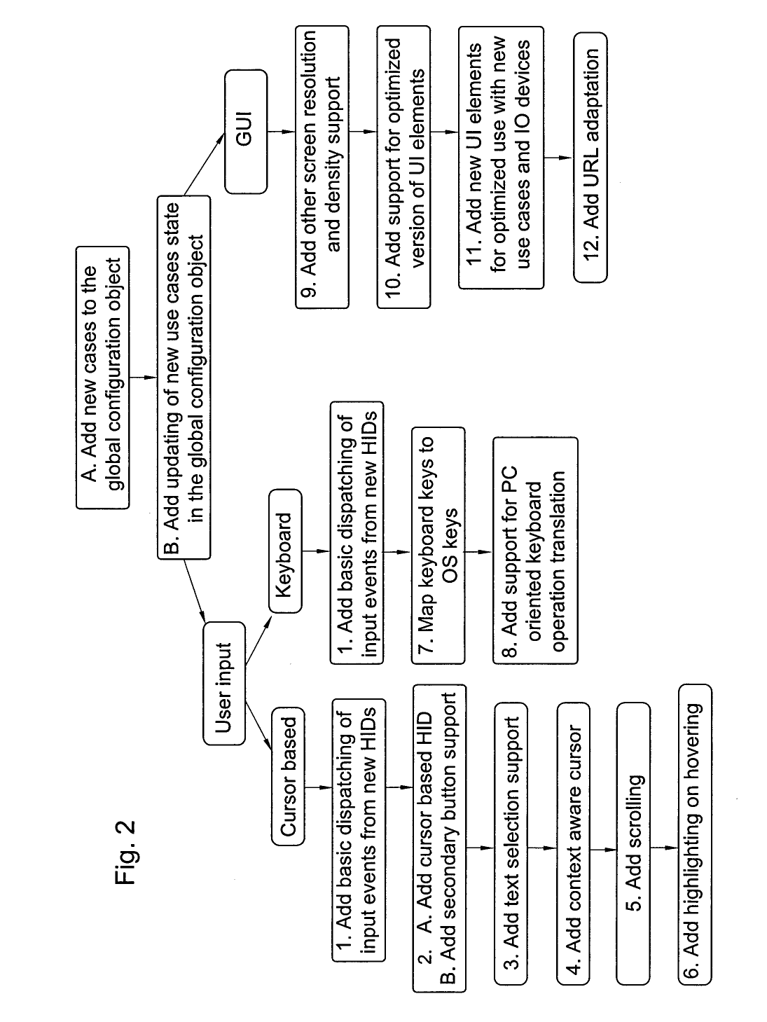

FIG. 1B is a simplified functional block diagram illustration showing the apparatus of FIG. 1A, according to certain embodiments of the present invention. As shown, an OS 110, such as an Android OS, resides within a pocket-sized mobile device 100 with pocket-sized hence inconvenient 10. The OS is modified, e.g. according to any of the teachings of FIG. 2 as described below, in order to allow it to accommodate to a user case or preferably to a selectable one of several use cases such as use cases A, B and C as shown. In use case A, the modified OS 120 piggybacks on a large, convenient HID 130. In use case B, the modified OS 120 piggybacks on a large, convenient output device 140. In use case B, the modified OS 120 piggybacks on a large, convenient HID 150 which differs from HID 130, and on a large, convenient output device 160 which differs from output device 140.

Any suitable wireless, docked or even wired technology may be employed to provide communication between the mobile device 100 of FIG. 1 and various of the IO devices it “piggybacks” upon, such as but not limited to Bluetooth for input devices, or WiDi or HDMI for output devices.

FIG. 2 is a simplified flowchart illustration of steps, some or all of which may be performed to adapt a conventional operating system to support the hopping mobile processor of FIG. 1. Typically, the changes and additions are made to the source code of the subject OS to be modified. The modification process of FIG. 2 may include one or both of the following 2 sets of steps which may be applied or added to an existing touch based OS: User Input modifications and GUI modification. Each of these sets is now described:

User Input modifications includes one or more modifications to the touch based OS which enables use which is optimized to or adapted to the HIDs which are used with the subject OS. An example of an optimized use with a mouse and a keyboard which is common in various OSs can be found in Microsoft Windows and includes the following operations a-g:

a. The mouse controls a cursor which changes according to the UI element under it (context aware cursor)
b. The mouse triggers the display of a context menu when its right button is clicked
c. The mouse triggers scrolling up/down when its scrollbar is used
d. The mouse allows marking of text when clicking its left button and dragging.
e. The keyboard enables performing copy and paste of text using the following key combinations respectively: Ctrl+C, Ctrl+V
f. The keyboard allows to switch between applications with the Alt+Tab key combination
g. The keyboard enables using the arrow keys to navigate between fields

GUI modification includes modifications and/or additions to the GUI of a touch based OS, which enables optimized or adapted use according to one or more of the current use case, HID devices used, and the display which is used. An optimized or adapted use may adjust display density, screen layout, UI elements display properties such as but not limited to size, spacing, padding, orientation. It may also add UI elements which were not part of the subject OS. Such elements enable optimized use by allowing easier and more powerful use in some use cases or with some input/output devices such as but not limited to HIDs and computer screens.

The method of FIG. 2 may include one, some or all of the following operations or steps, suitably ordered e.g. as shown:

Prerequisites: One or both of the following may be provided, as shown:
a. Add current use case to the global configuration object
b. Add updating of new use cases state in the global configuration object

Step 1. Add basic dispatching of input events from new HIDs

Step 2a. Add cursor based HID

Step 2b. secondary button support

Step 4. Add context aware cursor

Step 3. Add Text Selection Support

Step 7. Map keyboard keys to OS keys

Step 5. Add Scrolling

Step 8. Add support for PC oriented keyboard operation translation

Step 6. Add highlighting on hovering

Step 10. Add support for optimized version of UI elements

Step 11. Add new UI elements for optimized use with new use cases and IO devices

Step 9. Add other screen resolution and density support

Step 12. Add URL adaptation.

According to certain embodiments, prerequisite operations (a) and (b) are performed, in order to add new use cases to the global configuration object and to keep their state up to date. Certain embodiments of these operations are now described in detail.

FIG. 2, step A:

Use a global configuration object to track and represent some or preferably all of the current use case, input devices and screen info (resolution, density). If the subject OS contains such object, as in the android example, add extra fields to it to indicate the current use case, input devices and screen info; otherwise, add such object. The fields may be integers which indicate which HIDs and displays are used. It may also indicate which use case is used, such as productivity use case, or using the TV as the display. Clause 1 in the Android implementation example below includes a detailed android OS modification example.

FIG. 2, step B:

Add code which updates the extra fields according to connected IO devices (for example: mouse, tv, keyboard, tablet). The code may be added in a function which is called when a device is removed or added. Clause 2 in the Android implementation example herein includes a detailed android OS modification example.

### Example

For Android OS, a configuration object example may be found in android.content.res.Configuration class, and a method which is called for every added/removed device may be found in Android OS android.server.KeyInputQueue.mThread.run( ). An example representation of the current screen resolution and density is available in android, android.util.DisplayMetrics class.

Steps 1-12 of FIG. 2, which may be performed individually or in any suitable combination, according to alternative embodiments of the present invention, are now described in detail:

FIG. 2, Step 1. Add Basic Dispatching of Input Events from New HIDs:

In order to optimize the use of new, originally unsupported, HIDs, in the subject OS, suitable basic dispatching of the events from those HIDs into the subject OS may be added to the OS. When the HID can be supported by the OS, installing drivers as appropriate and connecting the HID suffices for the HID to start basic dispatching of the events to the OS. An example can be found at the following http link: groups.google.com/group/android-platform/browse_thread/thread/73eed70fb229d7ae.

When the HID is not supported by the OS, use a remote client running on a different machine to send the events to the subject OS device (e.g. over network/bluetooth), and inject the events to an existing input device, with different meta data to indicate a different origin. For example, receiving input events from a mouse connected to a remote machine over wifi, and writing the event to the file descriptor of the touch screen in the subject OS device. The event may include different keycodes/scancodes such as BTN MOUSE keycode in Android OS, in order to indicate that it came from a mouse.

FIG. 2, Step 2A. Add Cursor Based HID:

A cursor based HID may be added to the OS normally in the same way the touch screen or keyboard devices are added, but may be differentiated from other events by some meta data in the event received from the HID driver or injected event. When differentiated, the event created in the touch based OS according to the raw data from the driver may include meta data in order to keep it differentiated throughout the touch-based OS. Below is an example from the 0xdroid project where key_bitmask is the meta-data from the HID driver, and the “classes” field holds the met-data in the “device” object which represents an input device in the subject OS. In the example, when the meta-data from the driver indicates that the event originates from a mouse (“if” evaluation result is true), the object which represents a device in the subject OS (“device”) gets its meta-data set to CLASS_MOUSE in order to indicate that this event originates from a mouse throughout the system.

if (test_bit(BTN_LEFT, key_bitmask) && test_bit(BTN_RIGHT,
key_bitmask)) device->classes |= CLASS_MOUSE;

Another example can be found in clauses 4-6 in the Android implementation example herein.

In the event that the cursor based HID uses relative position, the touch based subject OS may be modified in order to support it, since touch based OSs usually support only absolute position input that touch screens provide. An example for adding support for relative input events can be found in clause 4 in the Android implementation example provided herein.

FIG. 2, step 2B. Add Secondary Button Support:

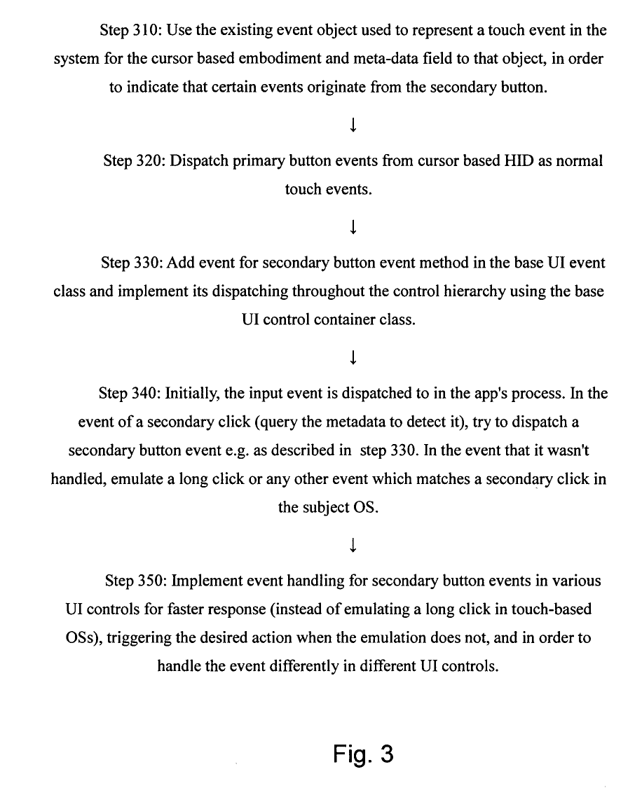

An optimized use in productivity use case includes a cursor based HID with a secondary button. Such a button, which often exists in touchpads, mouse, and trackballs, is usually not supported in touch based OSs. In order to add support for it, the subject OS is modified e.g. according to the method of FIG. 3. The method of FIG. 3 includes some or all of the following steps, suitably ordered e.g. as shown:

Step 310: Use an existing event object which is normally used to represent touch events in the system, add to this object a meta-data field which will indicate that certain events originate from the secondary button. For example, use the following field: android.view.MotionEvent.mMetaState in Android OS. Upon the creation of such event, set the meta data according to the button indication (primary/secondary) received from the OS or input event injection.

Step 320: Dispatch primary button events from cursor based HID as normal touch events.

Step 330: Add event for secondary button event method in the base UI event class and implement its dispatching throughout the control hierarchy using the base UI control container class. Pseudo-code: boolean dispatchSecondaryButtonEvent(EventObject event) {return handled;}

Step 340: Initially, the input event is dispatched to in the app's process (for example, ViewRoot.handleMessage( ) in Android OS). In case of a secondary click (query the metadata to detect it), try to dispatch a secondary button event as described in step 330. In the event that the secondary button event wasn't handled, emulate a long click or any other event which matches a secondary click in the subject OS. See clause 12 in the android examples section. Step 350: Implement event handling for secondary button events in various UI controls for faster response (instead of emulating a long click in touch-based OSs), triggering the desired action when the emulation does not, and in order to handle the event differently in different UI controls.

For example, in Android OS, it is possible to trigger the display of a context menu for a certain list item in list like UI controls by implementing a secondary button event handling in android.widget.AbsListView class, e.g. as follows:

```
@Override
protected boolean onMouseRightClickEvent(MotionEvent event) {
  mMotionPosition = findMotionRow((int)event.getY( ));
  if (mPendingCheckForLongPress == null) {
    mPendingCheckForLongPress = new CheckForLongPress( );
  }
  mPendingCheckForLongPress.rememberWindowAttachCount( );
  mPendingCheckForLongPress.run( );
  return true;
}
```

The action implemented in the secondary button event handling may be one which is common in PC OSs, for example context menu being displayed when pressing the right mouse button in Microsoft Windows. A more detailed implementation example can be found in clauses 3, 10, 12, 14, in the Android implementation example hereinbelow.

FIG. 2, Step 4. Add Context Aware Cursor:

Cursor preferably operates as a mouse/touchpad cursor as it appears in other OSs such as Ubuntu (Linux) and Microsoft Windows. Such cursor is a context aware cursor and it is controlled by cursor based HIDs.

The modification typically allows each UI control to determine the cursor type that may be displayed when the mouse cursor is over it. Thereby, each application that uses or inherits from the UI controls provided by the invention's OS, may support this feature. Applications that contain new UI controls that don't inherit from an existing similar UI control may be able to make the cursor change when above them by overriding a method created by the invention, according to certain embodiments, and by doing this, may make the cursor aware of them too.

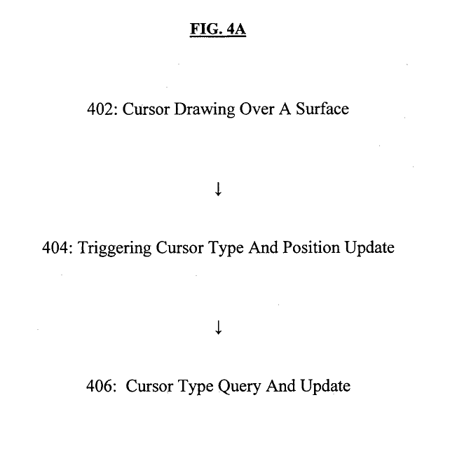

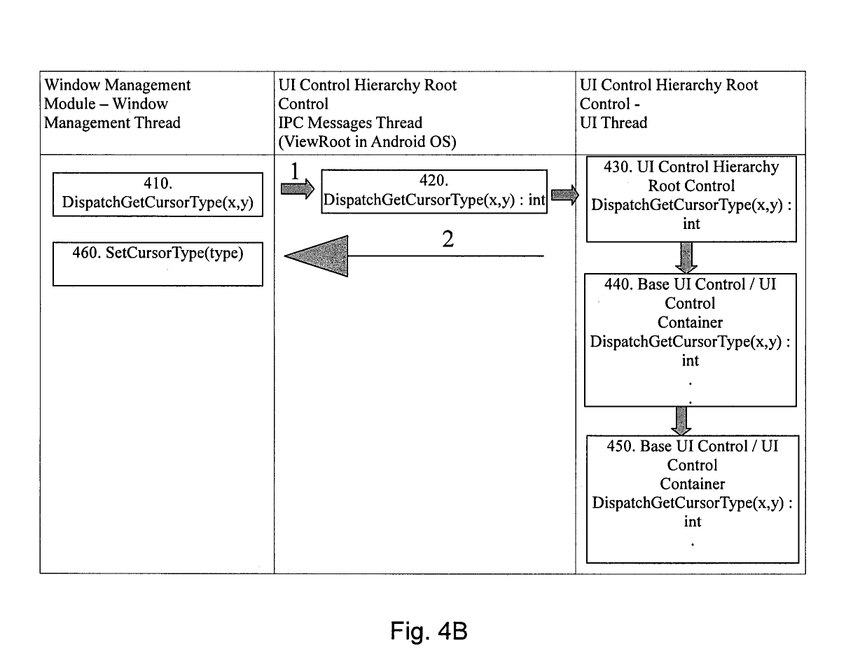

Step 4 in FIG. 2 may include some or all of the steps 402, 404 and 406 in FIG. 4A, suitably ordered e.g. as shown. Each of the steps of FIG. 4A is now described in detail.

FIG. 4, Step 402: Cursor Drawing Over a Surface:

In order to facilitate drawing of a cursor with a dynamic shape, an extra drawing surface may be added on top of the existing surfaces so its content is always visible. This surface may contain the cursor. The unpainted pixels of the surface may be translucent. The code adding this surface may be inserted into an existing subroutine that places the surfaces in the window management module or performs composition of the different surfaces of the running applications. As an example, in the Android. OS: WindowManagerService.performLayoutAndPlaceSurfacesLockedInner( ) may be used for this purpose. After the surface has been added, a default cursor is drawn on it.

The positioning of the cursor is typically done by changing the location of the cursor's surface according to the mouse coordinates. When the surface of the cursor is positioned, the coordinates may be computed with an offset from the coordinated retrieved from the mouse, according to the Hot Spot coordinates of the current cursor type. A detailed implementation example can be found in clause 6 in the Android implementation example.

FIG. 4, Step 404: Triggering Cursor Type and Position Update:

Cursor type and position update are triggered by adding a hook (method call) to the main input dispatching method of the OS, or to any method that all the inputs go through. Those updates may be triggered only when the dispatched input originates from a cursor based HID. A detailed implementation example can be found in clause 6 in the Android implementation example.

FIG. 4, Step 406: Cursor Type Query and Update:

A request asking for the cursor type matching the current coordinates of the mouse is dispatched from the window management module up to the UI control located on those coordinates which returns the cursor type associated with it to the window management module. The window management module paints the retrieved cursor type.

According to certain embodiments of the present invention:

A. the main window management module of the OS dispatches a request to the top element of the view hierarchy (may be a class that inherits from the base UI control or any class located at the top of the UI control hierarchy).
b. The class that inherits from the base UI control searches his child controls (if it has such) for a control with area that intersects with the mouse coordinates.
c. When it finds one, it dispatches the request to it.
d. Sub-steps B and C of step 406 are repeated for the control found in step 406's sub-step C, until the class inheriting from base UI control does not have or find child UI controls to forward the request to (e.g. due to non intersecting coordinates or it does not have/support child controls).
e. The UI control class that the request has reached returns the cursor type associated with it to the element at the top of the UI control hierarchy. The returning of cursor type is typically done by function return values throughout the call hierarchy.
f. The top element in the UI control hierarchy invokes a function in the window management module with the cursor type as a parameter. This function may paint the cursor image matching this cursor type.

An example implementation for step 406 is presented in FIG. 4B. A detailed implementation example for FIG. 4 can be found in clause 6 in the Android implementation example.

In FIG. 4B, optionally, if an existing OS uses its base UI control as the root UI control and not another specific class (such as the ViewRoot class in Android OS, for example), the method of the Window Management Module which dispatches a query for the current cursor type, hereafter referred to as DispatchGetCursorType, may call Base UI Control/UI Control Container DispatchGetCursorType(x,y) method directly, and by doing that, bypass the missing UI control root object. This form of input event dispatching from the window management module to a control in specific coordinates exists in various OSs such as Android OS for example.

Window Management Module—DispatchGetCursorType (block 410 in FIG. 4A):

Finds out which window has the focus currently and calls the DispatchGetCursorType method of its UI Control Hierarchy Root Control. A detailed implementation example can be found in clause 6 in the Android implementation example.

UI Control Hierarchy Root Control IPC Messages Thread—DispatchGetCursorType(x,y) Method (Block 420 in FIG. 4A):

This method is typically used to send a message to the UI thread of the same class that may initiate a call to the DispatchGetCursorType(x,y) method of the UI Control Hierarchy Root Control. A detailed implementation example can be found in clause 9 in the Android implementation example.

UI Control Hierarchy Root Control—UI Thread—DispatchGetCursorType(x,y) Method (Block 430 in FIG. 4A):

This method typically dispatches the cursor type query to the child UI control(type: base UI control type), and invokes the setCursorType method of the window management module with the result (cursor type—integer) as a parameter. A detailed implementation example can be found in clause 9 in the Android implementation example.

UI Control/UI Control Container DispatchGetCursorType(x,y) (Block 440 in FIG. 4A):

Base UI Control Container class implementation (ViewGroup in Android OS): The implementation iterates over the contained child controls, searching for control whose boundaries intersect with the specified coordinates (originating from the mouse). When such control is found, it forwards the request to this control by calling its DispatchGetCursorType(x,y) method with modified coordinates (scrolling involves offset of the coordinates). When such control is not found, GetCursorType( ) is called. A detailed implementation example can be found in clause 11 in the Android implementation example.

Base UI Control Class Implementation (View in Android OS):

This is a default implementation for simple controls that do not have child controls or areas inside the control that employ different cursor types. Calls GetCursorType( ) in order to get the cursor type matching this control and returns the return value from it. detailed implementation example can be found in clause 11 in the Android implementation example.

Base UI Control—GetCursorType( ) (Block 450 in FIG. 4A):

Returns the cursor type matching the control, represented by an integer. The implementation in the Base UI control returns the default cursor type. By overriding this function in various controls, a different cursor type may be returned for each control. A detailed implementation example can be found in clause 11 in the Android implementation example.

Window Management Module—SetCursorType(type) (Block 460 in FIG. 4A):

For each cursor type an image file containing the cursor's image is kept within the resource files of the OS. In this method, the image matching the specified cursor type is painted onto the cursor's surface described earlier. Any cursor positioning that may take place after this cursor image drawing, may change the location of the new cursor. A detailed implementation example can be found in clause 6 in the Android implementation example.

FIG. 2, Step 3. Add Text Selection Support:

The invention, according to certain embodiments modifies the text selection mechanism of the touch base OS so it may enable the user to mark text for selection in the method in an optimized manner. This manner is conventionally used in cursor based UIs. For example, in Open Office Word Processor, in order to select text, the user may press the left mouse button over the beginning of the selected text, move the mouse to the end of the selected text and release the button. The invention, according to certain embodiments, adds the conventional cursor based selection method to the base text viewing and editing UI control of the OS. By doing this, every application that uses or inherits from the base text viewing and editing UI control provided by the OS may have the selection mechanism suited for cursor based UIs.

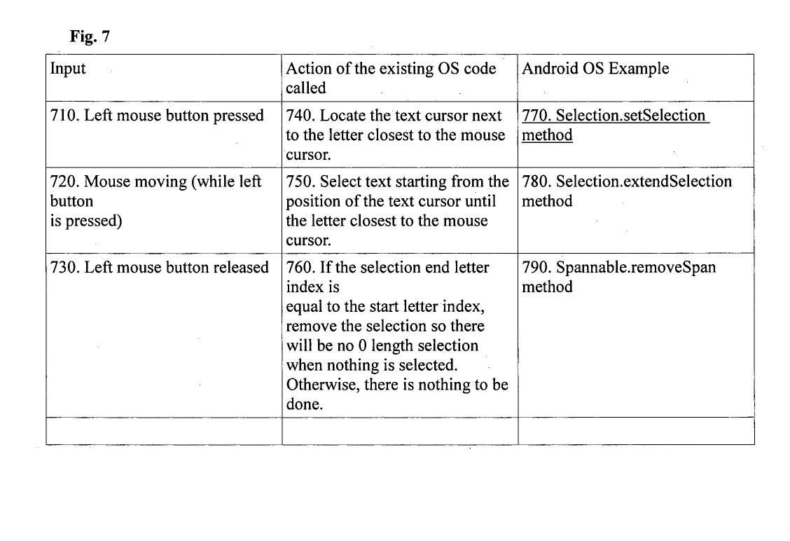

The modification of the text selection mechanism may include modifying the module that selects the text according to the user input. For example, in Android OS it is done by the on TouchEvent method of the TextView class—the UI control that displays text. In the text selection module, mouse based text selection is implemented by calling the existing text selection code of the existing OS for every mouse input event. This code is used for touch based text selection and the modification is composed of executing the matching part of this code for every mouse event, e.g. as shown in FIG. 7. A detailed implementation example can be found in clause 19 in the Android implementation example.

FIG. 7 shows mapping of pointer based HID operation to operation in the existing OS.

FIG. 2, Step 7. Map Keyboard Keys to OS Keys:

In order to map the keys of a new, external keyboard, assuming the subject OS has already support for any kind of keyboard:

a. Find the module which is also responsible for translating between key codes read from the keyboard driver to key codes of the subject OS.

b. Modify the current mapping module to use a different map for the new, external keyboard, which may map its key codes to the modified OS key codes.

An example for such module can be found in Android OS frameworks/base/libs/ui/EventHub.cpp, and various maps (.kl files) may be found in a subdirectories of the “device” folder of the Android OS source code.

FIG. 2, Step 5. Add Scrolling:

In touch based OSs, some of the UI controls are scrollable (support scrolling), and some are not. The conventional scroll behavior when the user scrolls is performing scrolling in the control which is the first (lowest in ui control tree) scrollable control containing (surrounding) the control pointed by the mouse cursor.

This may be achieved by dispatching a scroll event(action) through the UI control hierarchy and handling the scroll event (perform scroll) in the first scrollable control located up in control hierarchy (assuming the root is at the top) above the control matching the mouse coordinates. This process may be implemented in the base UI container control, in a new function. The same function may be implemented in the base UI control, but may do nothing and return always false. The scrolling event is dispatched from the window management module as every other input event is dispatched and as the mouse cursor type request is dispatched. The process is specified in the following pseudo-code that represents the described function in the base UI container control:

```
child = findIntersectingChild (iterates over child controls and finds a
child with intersecting boundaries)
handled  = child.dispatchScroll(pointingDeviceXCoordinate,
pointingDeviceYCoordinate, xAxisScrollDistance, yAxisScrollDistance)
if not handled && this control supports scrolling
    thisControl.scroll( xAxisScrollDistance, yAxisScrollDistance)
    return true
else
    return false
```

An implementation of this method may be added in the base UI control. This implementation may just return false. Another way to implement scrolling is to map the mouse scroll wheel events to arrow/trackball key codes in the subject OS. For example, in Android OS, scrolling up event may be mapped to KeyEvent.KEYCODE_DPAD_UP.

FIG. 2, Step 8. Add Support for PC Oriented Keyboard Operation Translation:

In use cases which include a keyboard, optimized use allows using keyboard operations which are not originally supported by the subject OS, such as shortcuts, key combinations and special keys. According to certain embodiments, logic is added to an existing method in the OS that gets every pressed key as a parameter and executes general policy according to the current dispatched key or any other data (for example, interceptKeyTi and interceptKeyTq methods in WindowManagerPolicy in the android OS). If no such method exists, it may be implemented in other places in the key event dispatching call hierarchy of the subject OS.

The added logic checks if the current input key matches one of the translated keyboard operations and executes the action associated with this keyboard operation. For example, the logic may check if alt+tab was pressed and then execute a method in another module that switches to another application and displays a list of current running applications (long click on home button in Android OS).

FIG. 2, Step 6. Add Highlighting on Hovering:

In some use cases, optimized use allows the user to identify the UI element which the cursor (which may be controlled by mouse) is pointing at by highlighting that UI element. Such highlighting may be found in Microsoft Windows when using the arrow keys or the tab key to highlight/focus a different control from the current one. In order to find the item to be highlighted under the current cursor position, the item may be searched using a method similar the one above, which was specified for cursor type query. Once found, the item may be marked using the existing code of the OS used for setting the focused control.

Typically,

a. a request asking to highlight the UI control matching the current coordinates of the cursor is dispatched from the window management module up to the deepest (in control tree), focusable UI control in the specified coordinates. In the UI control, in the event that such was found, the internal focus feature support is used to highlight the control.

b. According to certain embodiments of the present invention, the main window management module of the OS dispatches a request to the top element of the view hierarchy (may be a class that inherits from the base UI control or any class located at the top of the UI control hierarchy)

c. The class that inherits from the base UI control searches his child controls (if it has such) for a control with area that intersects with the specified coordinates and is focusable. When it finds one, it dispatches the request to it.

d. The previous step (c.) is done until the class inheriting from base UI control does not have or find child UI controls to forward the request to (e.g. due to non intersecting coordinates, non focusable, or it does not have/support child controls).

d. The UI control class that the request has reached to uses its internal method which is typically used internally for focusing. For example, the View.handleFocusGainlnternal method in Android OS.

In some Oss, UI controls may be set up to block the dispatching of focus to their child controls. In such case, the highlighting request may be forwarded to their child controls. An example for this setting is the View.FOCUS_BLOCK_DESCENDANTS in Android OS.

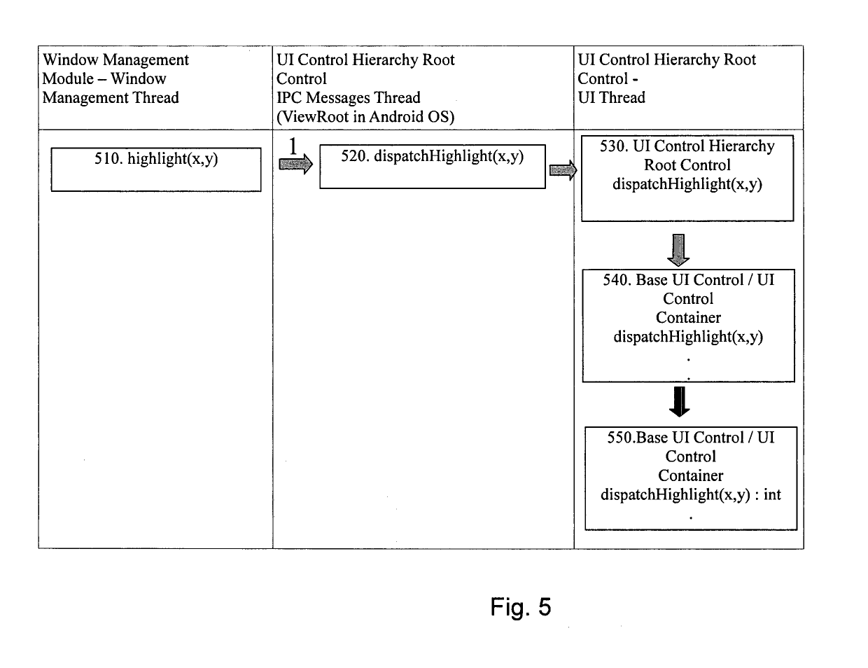

An example implementation of FIG. 2, step 6 is presented in FIG. 5. Optionally, in the event that existing OS uses its base UI control as the root UI control and not another specific class (such as the ViewRoot class in Android OS, for example), the method of the Window Management Module which dispatches a request for highlighting a UI control, hereafter referred to as dispatchHighlight(x,y), may call Base UI Control/UI Control Container dispatchHighlight(x,y) method directly, and by doing that, bypass the missing UI control root object.

All of the methods are added by the invention, according to certain embodiments. This form of input event dispatching from the window management module to a control in specific coordinates exists in various OSs such as Android OS for example.

Step 510. Window Management Module:

Generally, this module finds out which window has the focus currently and calls the dispatchHighlight method of its UI Control Hierarchy Root Control. In the event that another window has a control currently highlighted, the module calls the window's finishHighlight( ) method in order to clear the highlight in the previous window which is now out of scope.

Step 520. UI Control Hierarchy Root Control IPC Messages Thread—dispatchHighlight(x,y) Method:

This method is typically used to send a message to the UI thread of the same class that may initiate a call to the dispatchHighlight(x,y) method of the UI Control Hierarchy Root Control.

Step 530. UI Control Hierarchy Root Control—UI Thread—dispatchHighlight(x,y) Method:

This method typically dispatches the highlighting request to the child UI control(type: base UI control type).

Step 540 and 550. UI Control/UI Control Container dispatchHighlight(x,y):

Base UI Control Container class implementation (ViewGroup in Android OS): The implementation iterates over the contained child controls, searching for control whose boundaries intersect with the specified coordinates (originating from the cursor) and is focusable. When such control is found, it forwards the request to this control by calling its dispatchHighlight(x,y) method with modified coordinates (scrolling involves offset of the coordinates). When such control is not found, dispatchHighlight(x,y) of the base UI control class is called.

Base UI Control Class Implementation (View in Android OS):

This is a default implementation for simple controls that do not have child controls. When the control is focusable, calls the internal method which is typically used internally for focusing in order to highlight the control.

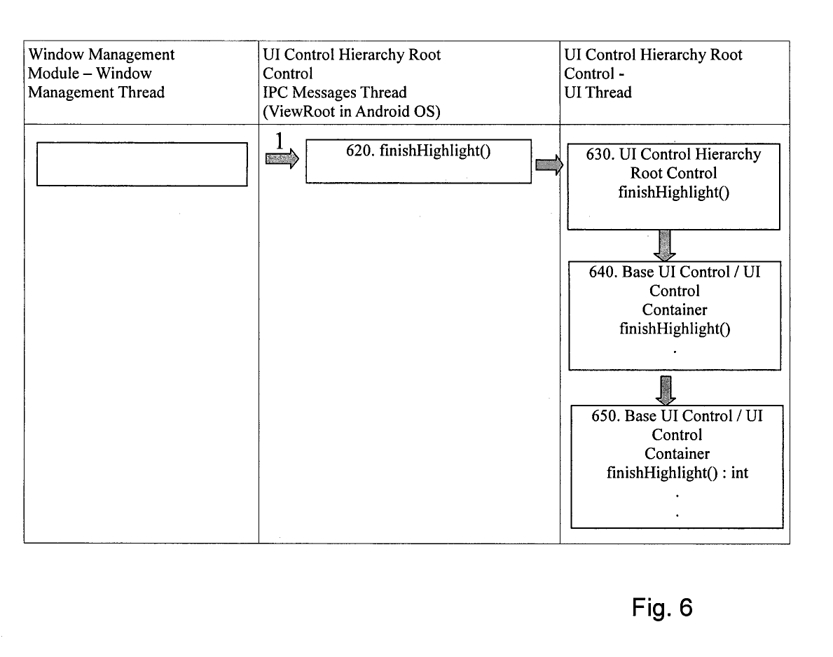

In order to remove the highlighting, a similar flow may be used, as described by FIG. 6.

FIG. 2, Step 10. Add Support for Optimized Version of UI Elements:

According to certain embodiments, alternative versions of UI elements and screen layouts and a method of displaying them are created according to the display and input device used. The alternative version allows an optimized use according to the use case and the input devices used. Examples:

a. when displayed in a car integrated touch screen, alternative dialing buttons layout (number buttons) are displayed, which are bigger and/or are in landscape rather than portrait orientation.

b. Since touch based OSs are built for touch screen input, the UI controls are made very large in order to facilitate easy touch screen based use. Their large size is bothersome, because for example, less content may be squeezed into the screen, and when a menu appears it obstructs a large part of the screen. Since when a cursor is used there is no need for such large controls, the invention, according to certain embodiments may also adjust the layout and diminish the size of various UI controls so as to adapt for cursor based HID.

The invention, according to certain embodiments modifies various resource files and actual layout/styling code. The modification typically comprises creating an alternative version for every UI control and screen layout and a method for showing the optimized version for every input device and display device combination. The invention then selects in run time the resources and layout code according to the input/output devices used and use case (TV/car/tablet/PC like). One possible implementation is now described:

In the event that the subject OS contains a module responsible for selecting a resource version according to current configuration or state, modify the version selecting module so it is also able to select resources according to the connected IO devices and use case as mentioned above. The state of those IO devices and use state may be acquired from the global configuration object. In the event that such module is not available, add one based on a suitable OS such as Android OS.

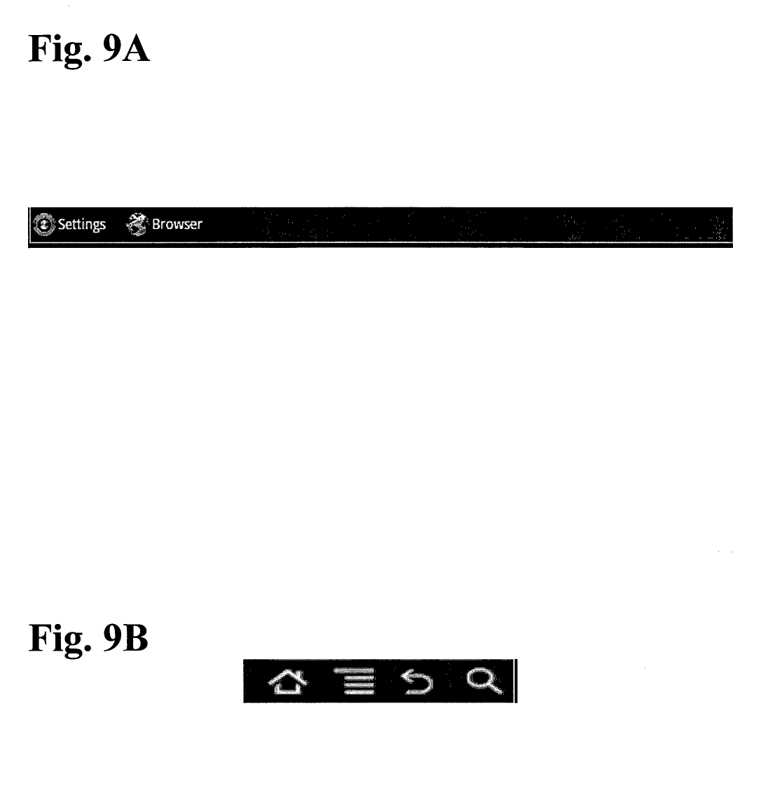

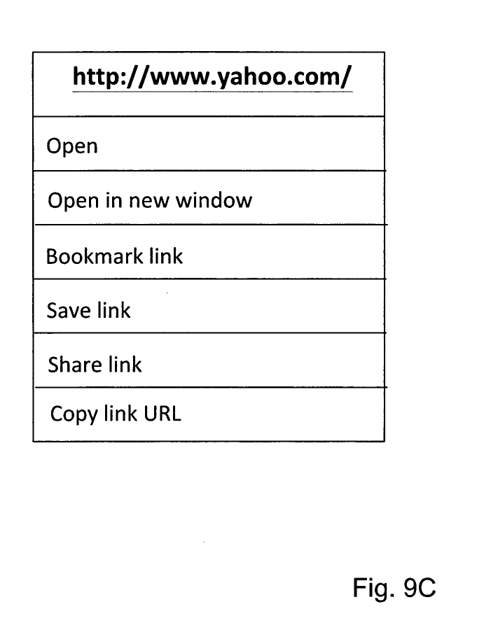

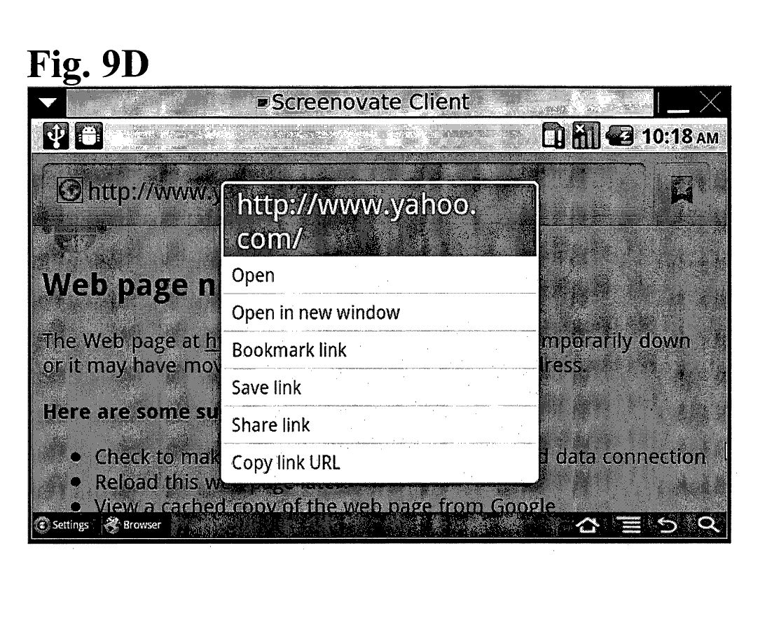

An Android example of diminished dialog is implemented by the graphic element of FIG. 9C, shown in context in the example screenshot of FIG. 9D.

FIG. 2, Step 11. Add New UI Elements for Optimized Use with New Use Cases and IO Devices:

In order to allow an optimized use in some ue cases, new UI elements may be added to the subject OS which may be displayed when some use cases are detected. The added UI elements provide optimized use based on at least one of the characteristics of the HIDs, the display used, and the use case. Such characteristics may include some or all of the following: larger screen, higher screen resolution, more accurate input device (such as mouse), external input devices (such as gamepad, joystick, keyboard, mouse, touchpad, trackball). The use cases may use the subject OS with: a car integrated touchscreen, a tv screen, a tablet, or in a productivity use case.

### Examples

a. when using a smartphone which has its graphics/display displayed over an LCD screen and is used with a mouse: Adding a task bar to the OS in such use case uses the accuracy of the mouse(as opposed to a touchscreen) and the additional screen real estate created by the larger screen with the higher resolution, to provide a better user experience (easier switching between tasks).

b. when the device running the modified OS is used with an external touchscreen which doesn't contain all the physical buttons housed in the said device, the missing physical buttons may be displayed as software buttons on the external touch screen.

c. running the modified OS on a device which doesn't house all of the physical buttons required by the original, unmodified OS or usually housed within the device running the original, unmodified OS.

For example, the above task bar may be implemented in the following manner:

Assuming the task bar is located at the bottom of the screen, a task bar UI control with fixed size is added and sets the screen area allocated for applications to start above it. Also, a hook (method call) is added to the method that is responsible for executing applications in OS or to any other method that always executes when an application starts. This hook may execute a method that updates the task bar e.g. using the following logic:

a. Build a list of N last executed applications containing the title, icon and data useful for re-executing the application (for example, an Intent object in Android OS). The list may be built by querying the OS for those items.
b. Clear the task bar UI control from previous icons and titles.
c. Create list of UI controls. Each control contains a text UI control that contains the title and an image UI control that contains the task's icon.
d. Add the UI control list to the task bar

When the user clicks an item in the task bar, execute or resume the application according the data saved in clause A (“Build a list of N last executed applications containing the title, icon and data useful for re-executing the application (for example, an Intent object in Android OS). The list may be built by querying the OS for those items.”).

The task bar may be implemented in a separate background process. The task bar may be displayed/hidden in a configuration change event handler:

1. When the event is handled the global configuration object may be queried tor the current use case.
2. The task bar may be displayed/hidden according to the results of the query. For example, if a cursor based HID is connected and a large, high resolution screen is used (productivity use case), the task bar may be displayed. Otherwise, it may be hidden.

The UI elements typically appear/disappear when the use case, and connected IO devices change. This may be implemented in the configuration change event handler. A detailed implementation example of the above embodiment may be found in clauses 16-17 in the Android implementation example. An example Android implementation screen capture is implemented by the graphic element of FIG. 9A, shown in context in the example screenshot of FIG. 9D.

Display physical buttons as software buttons e.g. with reference to FIG. 2, step 11 as described herein.

In some use cases in which the device with the touch based OS is used with an input device other than its own touch screen (excluding touch pad emulation), software buttons may be added. The software buttons replicate the action of the physical buttons in order to enable activation of the actions of the physical buttons via the input device which may not include them. Example scenarios: using a smartphone which has its graphics/display displayed over an LCD screen and is used with a mouse, using a smartphone connected to, and having its graphics/display displayed wirelessly over, an external touchscreen and the user uses the external touchscreen (lacking the smartphone's physical buttons) instead of the smartphone's touchscreen.

The software buttons may be displayed at all times or may be hidden in some cases such as while the displayed app employs a full screen display mode. A stripe at the bottom of the screen with software buttons may be implemented by:

a. Creating a UI control which contains a button for every physical button which its replication is desired.
b. Setting the click event of the button to inject the same key code the physical key sends. The key code may be injected to the system through the window management module, for example, in Android, e.g. using the com.androir.server.WindowManagerService.injectKeyEvent method.
c. Adding the UI control at the bottom of the screen in a global window management module, so it is there at all times and occupies space, such that apps' display area starts above it.

A detailed implementation example in which the physical buttons are integrated into the above task bar is provided herein in clause 16 in the Android implementation example set out hereinbelow. is implemented by the graphic element of FIG. 9B, shown in context in the example screenshot of FIG. 9D.

FIG. 2, Step 9. Add Other Screen Resolution and Density Support:

When using an external screen, optimized use may include using a screen resolution different than the one used in the device running the subject OS. In order to allow this optimization the subject OS is further modified to operate e.g. as follows:

Upon connection to a new display device (such as a remote screen or projector), the system receives from the remote screen the resolution of the remote display.

The system then computes memory resources required or to be employed for the display, e.g. by performing the following computation: X resolution×Y resolution×Bits per pixels

and comparing the result to the total amount of free video memory. If the required amount is smaller then the available amount, the remote display resolution is picked. If the required memory amount is greater then the available amount, a maximal available resolution may be computed that has the same aspect ratio between x and y as the requested remote screen resolution but the memory required is within system limits.

The system then consults a table which maps densities resolutions, based on total number of pixels supported by the display. The values of densities per number of pixels in the table can typically be changed by the user according to personal preference.

With the selected resolution and density, the system then re-configures the frame buffer memory to the new resolution and density settings restarts the graphical system.

As an example, a suitable Android implementation of the above may be accomplished by performing the following steps:

1. Shutting down the Android system server (same as ADB shell “stop” command)

2. Opening the/dev/graphics/fb0 frame buffer character device file and getting a file descriptor for it.

3. Issuing the FBIOSET_VSCREENINFO ioctl operation on the frame buffer file descriptor, with parameters of the new X and Y resolutions and virtual resolution of Y and 2×X.

4. Set the qemu.sf.lcd_density setting to the chosen density.

5. Closing the frame buffer file descriptor.

6. Restarting the Android system server (same as ADB shell “start” command)

FIG. 2, step 12. Add URL Adaptation:

In order to provide a browsing experience which is optimized for the current use case, the HTTP user-agent header which is sent by the browser (the browser which is typically distributed with the subject OS) may be modified. The user-agent HTTP header is adjusted according to the current use case. For example, when the current use case is the productivity use case, the user-agent header may be set to one which is typically sent from PCs, and when the current use-case is a normal smartphone use case, the user-agent may be set to the original one (of the subject OS). For example:

PC user-agent: Mozilla/5.0 (X11; U; Linux x86_{—}64; en-US) AppleWebKit/534.7 (KHTML, like Gecko) Chrome/7.0.517.44 Safari/534.7

Smartphone user-agent: Mozilla/5.0 (Linux; U; Android 1.1; en-gb; dream) AppleWebKit/525.10+(KHTML, like Gecko) Version/3.0.4 Mobile Safari/523.12.2

The URL adaptation may be implemented in a configuration change event handler:

1. When the event is handled, the global configuration object may be queried for the current use case.
2. The user-agent may be set according to the results of the query. For example, if a Cursor based HID is connected and a large, high resolution screen is used (productivity use case), the user-agent may be set to one typically sent by PCs.

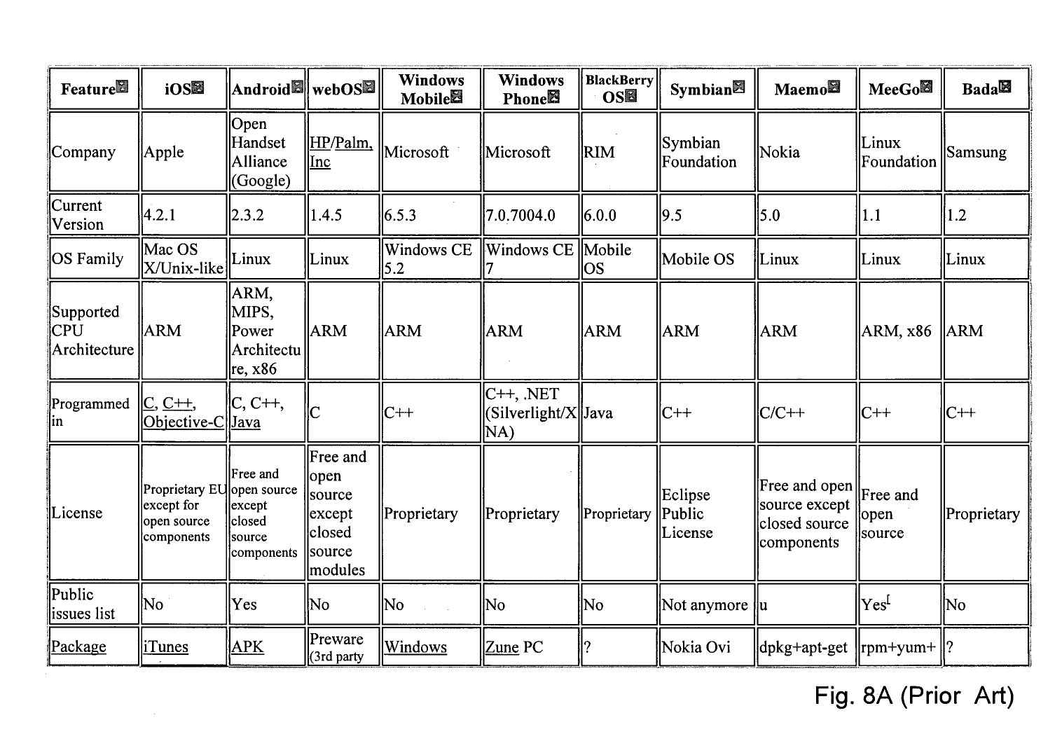

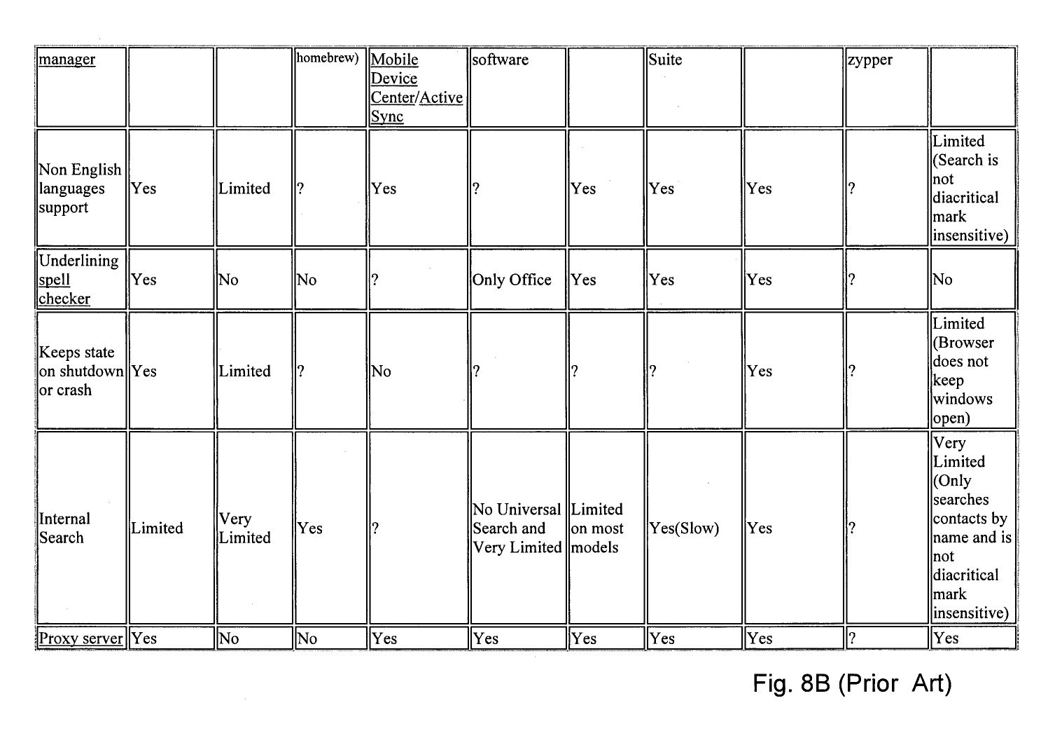

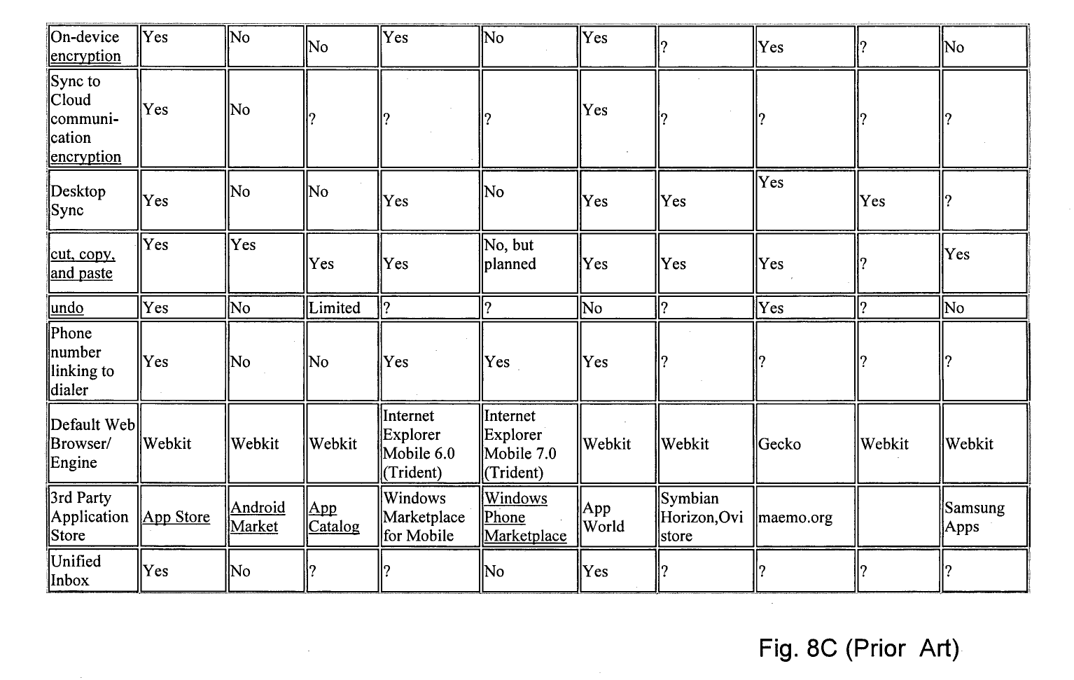

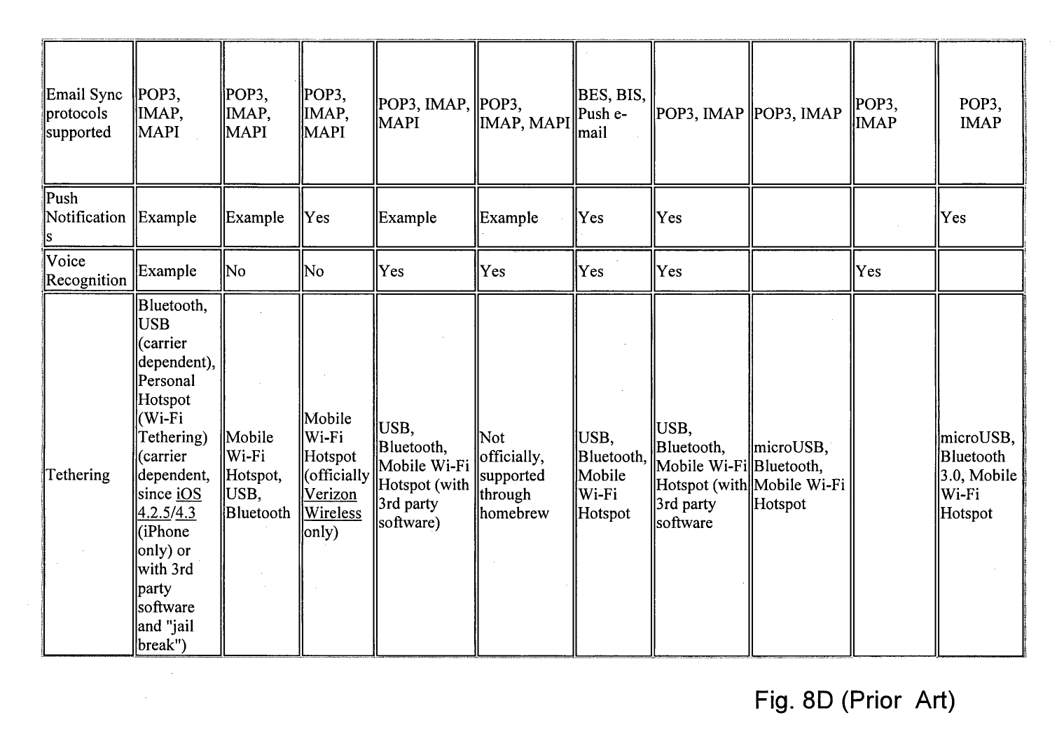

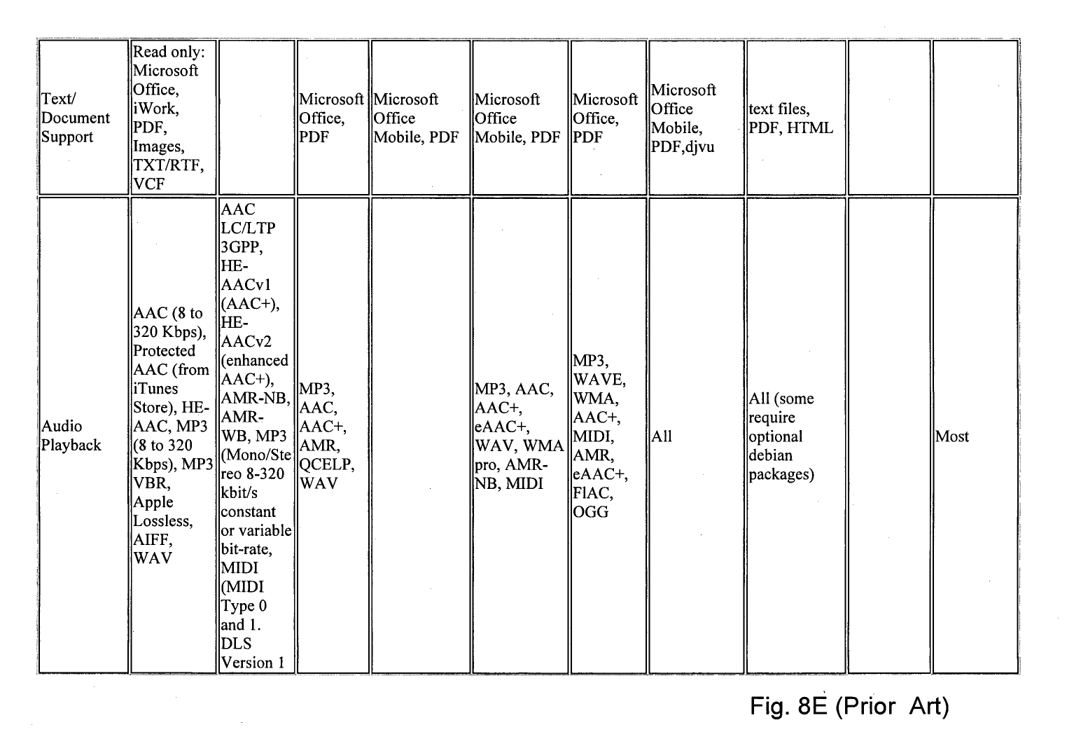

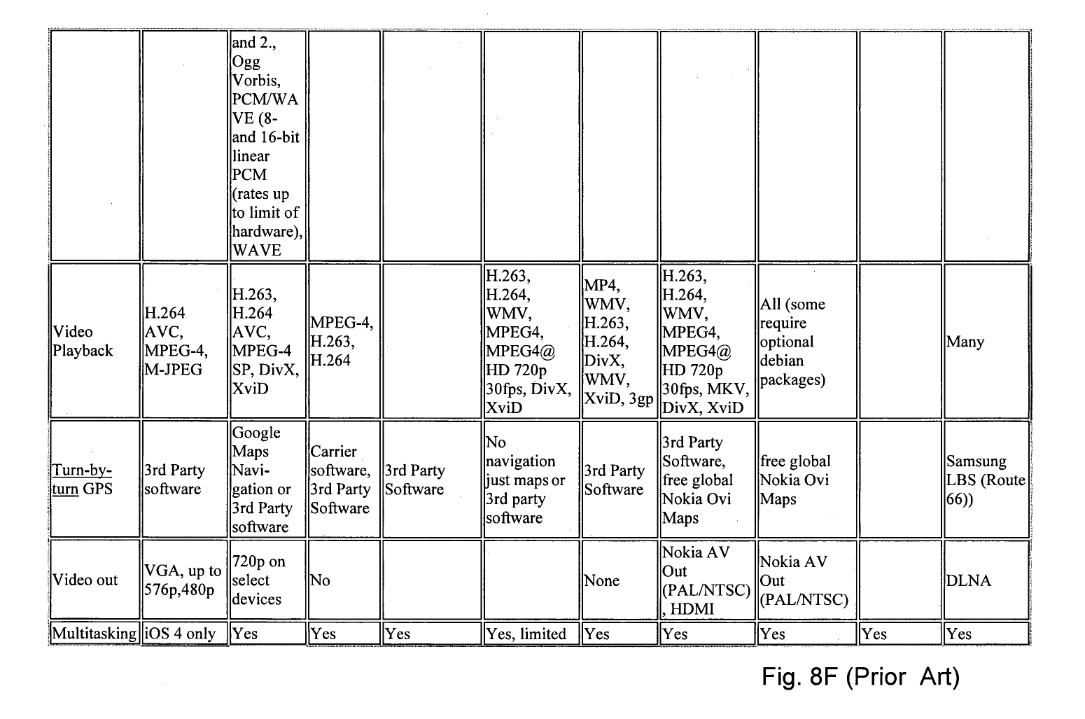

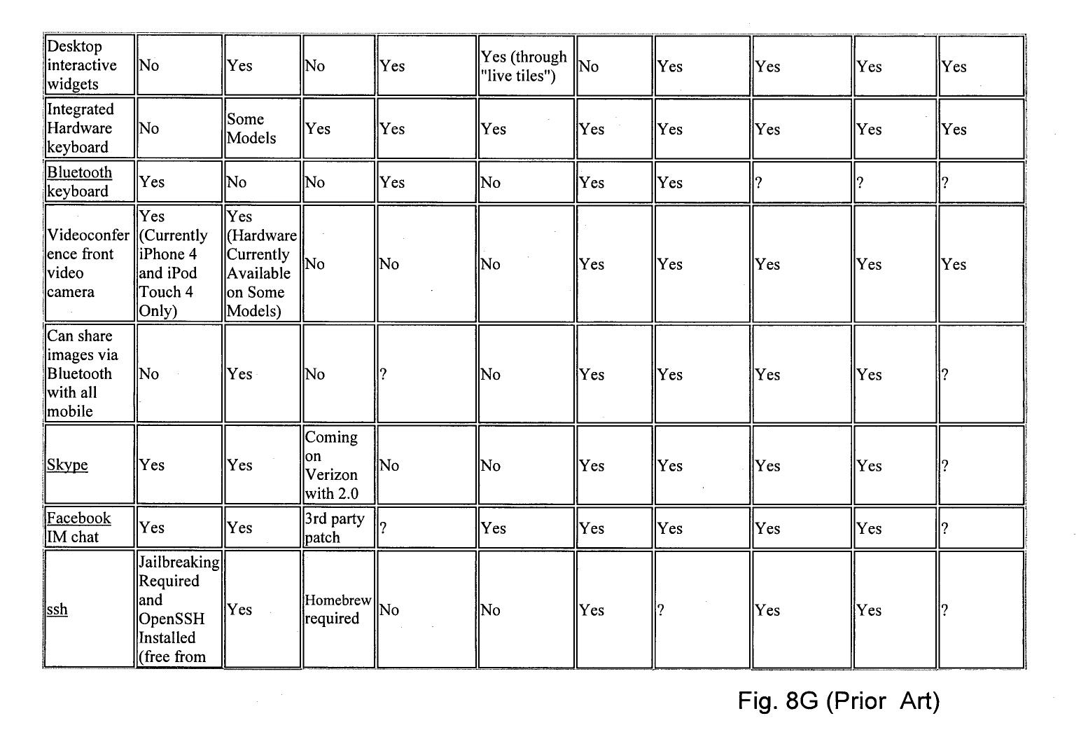

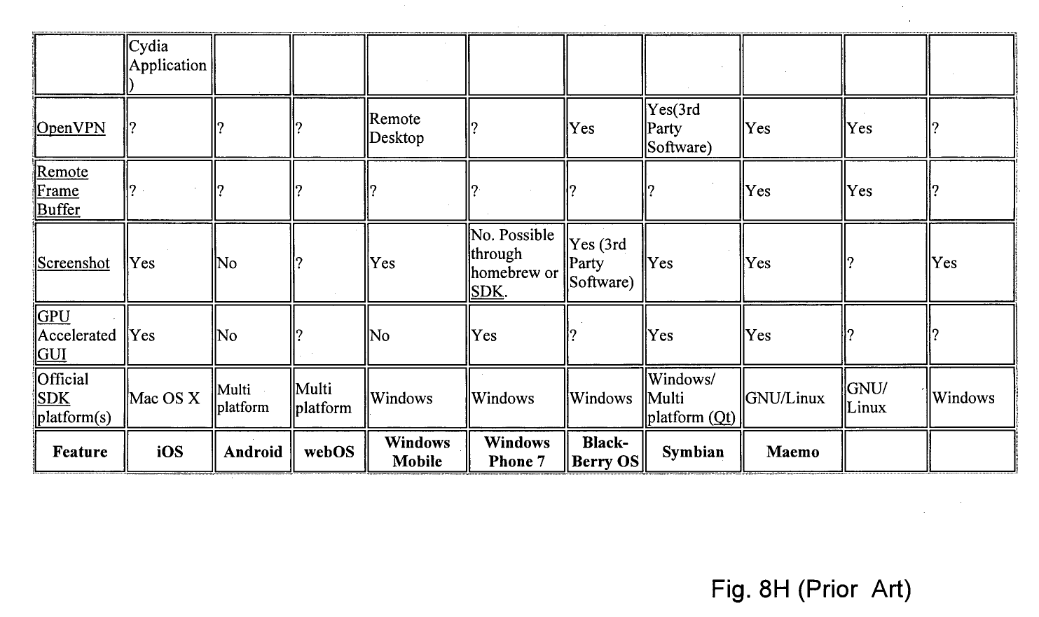

FIGS. 8A-8H, taken together, form a table setting out various types of mobile operating systems. It is appreciated that the apparatus and methods described herein with reference to FIGS. 1A-2 may be operative inter alia in conjunction with any suitable mobile operating system such as any touch OS or any operating system including some or all of the characteristics and aspects set out in the table of FIGS. 8A-8H, in any suitable combination.

It is appreciated that any suitable combination of the embodiments described above may be implemented as appropriate for an individual application and environment, e.g. by performing a corresponding suitable subset of the steps of FIG. 2.

### Example

An example Android implementation of a combination of various of the embodiments shown and described hereinabove, is now described. The implementation is based on Android 2.2. The implementation may include some or all of the following clauses 1-19. Clause 1 may include some or all of subclauses a-j. Clause 2 may include some or all of subclauses a-b. Clause 3 includes a subclause a. Clause 4 may include some or all of subclauses a-k. Clause 5 includes a subclause a. Clause 6 may include some or all of subclauses a-g. Clause 7 includes a subclause a. Clause 8 includes a subclause a. Clause 9 may include one or both of subclauses a-b. Clause 10 may include some or all of subclauses a-c. Clause 11 may include some or all of subclauses a-d. Clause 12 may include some or all of subclauses a-b. Clause 13 includes a subclause a. Clause 14 includes a subclause a. Clause 15 includes a subclause a. Clause 16 may include some or all of subclauses a-c. Clause 17 may include some or all of subclauses a-s. Clause 18 may include some or all of subclauses a-c. Clause 19 may include some or all of subclauses a-d. Clauses 1-19 according to certain embodiments of the present invention are now described:

### Clause 1:

android.content.res.Configuration Modifications:
a. Add the following code1 to android.content.res.Configuration to represent mouse in the global configuration object:

```
Code1:
/**
  * @hide
  */
  public static final int MOUSE_UNDEFINED = 0;
  /**
  * @hide
  */
  public static final int MOUSE_NOMOUSE = 1;
  /**
  * @hide
  */
  public static final int MOUSE_STANDARD = 2;
  /**
  * The kind of mouse attached to the device.
  * One of: {@link #MOUSE_NOMOUSE},
  * {@link #MOUSE_STANDARD}. @hide
  */
  public int mouse;
```

b. To allow setting of the config object according to another one, add to the setTo method, at the end:

mouse = o.mouse;

c. In order to allow string representation to include the mouse, add to the toString( ) method, after

```
“sb.append(screenLayout);” :
    sb.append(″ mouse=″);
    sb.append(mouse);
```

d. Add to the setToDefaults method, at the end:

mouse = MOUSE_UNDEFINED;

e. In order to allow updating the mouse from another config, add to the updateFrom method, right before the return statement:

```
if (delta.mouse != MOUSE_UNDEFINED
    && mouse != delta.mouse) {
  changed |= ActivityInfo.CONFIG_MOUSE;
  mouse = delta.mouse;
}
```

f. To allow diff according to the mouse too, add to the diff method, right before the return statement:

```
if (delta.mouse != MOUSE_UNDEFINED
    && mouse != delta.mouse) {
  changed |= ActivityInfo.CONFIG_MOUSE;
}
```

g. Add to the writeToParcel method, at the end:

dest.writeInt(mouse);

h. Add to the readFromParcel method at the end:

mouse = source.readInt( );

i. Add to the compareTo method, before the return statement:

if (n != 0) return n;
n = this.mouse − that.mouse;

j. To keep the hash code unique, add to the hashCode method, before the semicolon:

+ this.mouse

### Clause 2:

com.android.server.KeyInputQueue Class Modifications:
a. Add to the getInputConfiguration method, after the “synchronized” statement:

config.mouse = Configuration.MOUSE_NOMOUSE;

b. After:

```
if ((d.classes&RawInputEvent.CLASS_DPAD) != 0) {
            config.navigation
                = Configuration.NAVIGATION_DPAD;
            //Slog.i(“foo”, “***** HAVE DPAD!”);
          }
```

Add, to set the mouse property when mouse is being connected:

```
else if ((d.classes&RawInputEvent.CLASS_MOUSE) != 0) {
            config.mouse
                = Configuration.MOUSE_STANDARD;
          }
```

To indicate whether or not a mouse is connected.

### Clause 3:

a. Add the following secondary button meta state constants to android.view.keyEvent:

/**

* @hide
*/
public static final int META_MOUSE_EVENT = 0x4000;
/**
* @hide

*/
public static final int META_MOUSE_RIGHT_BUTTON_EVENT =
0x8000;

### Clause 4:

com.android.server.KeyInputQueue Class Modifications:
a. Add new type of event to android.view.RawInputEvent:

public static final int CLASS_MOUSE = 0x00000080;

b. In frameworks/base/include/ui/EventHub.h, add to the event classes enumaration:

| | |
|---|---|
| CLASS_MOUSE | = 0x00000080 |

c. In order to differentiate the mouse events by differentiating (marking) the mouse events from the added HID with CLASS_MOUSE, modify:

if (test_bit(REL_X, rel_bitmask) && test_bit(REL_Y, rel_bitmask)) {

device−>classes |= CLASS_TRACKBALL;

}
to:
if (test_bit(REL_X, rel_bitmask) && test_bit(REL_Y, rel_bitmask))

device−>classes |= CLASS_MOUSE;

else

device−>classes |= CLASS_TRACKBALL;

In com.android.server.KeyInputQueue:

d. add mouse coordinates tracking fields:

int mCx;
int mCy;

e. at the end of the setDisplay method, add initial coordinates setup:

mCx = mDisplayWidth / 2;
mCy = mDisplayHeight / 2;

f. In the input device reader thread “run( )” method, change:

if (ev.type == RawInputEvent.EV_KEY) {

di.mMetaKeysState = makeMetaState(ev.keycode,
ev.value != 0, di.mMetaKeysState);

mHaveGlobalMetaState = false;

}

to:

if (ev.type == RawInputEvent.EV_KEY

&& (di.classes & RawInputEvent.CLASS_MOUSE) != 0) {

di.mMetaKeysState = makeMouseMetaState(ev);
mHaveGlobalMetaState = false;

} else if (ev.type == RawInputEvent.EV_KEY) {

di.mMetaKeysState = makeMetaState(ev.keycode,

ev.value != 0, di.mMetaKeysState);

mHaveGlobalMetaState = false;

}

in order to add meta state to the mouse event according to meta state in the RawInputEvent processed.
g. In the same method, change:

if (ev.scancode == RawInputEvent.BTN_TOUCH &&

(classes&(RawInputEvent.CLASS_TOUCHSCREEN

|RawInputEvent.CLASS_TOUCHSCREEN_MT))
== RawInputEvent.CLASS_TOUCHSCREEN) {

to:

if ((ev.scancode == RawInputEvent.BTN_TOUCH ∥

ev.scancode == RawInputEvent.BTN_MOUSE) &&
(classes&(RawInputEvent.CLASS_TOUCHSCREEN

|RawInputEvent.CLASS_TOUCHSCREEN_MT))
== RawInputEvent.CLASS_TOUCHSCREEN) {

h. In the same method, In order to enable dispatching of mouse events through the touch events dispatching mechanism, change:

if (ev.scancode == RawInputEvent.BTN_MOUSE &&

(classes&RawInputEvent.CLASS_TRACKBALL) != 0) {

di.mRel.changed = true;
di.mRel.mNextNumPointers = ev.value != 0 ? 1 : 0;
send = true;

}

to:

if (ev.scancode == RawInputEvent.BTN_MOUSE) {

if ((classes&RawInputEvent.CLASS_TRACKBALL) != 0) {

di.mRel.changed = true;
di.mRel.mNextNumPointers = ev.value != 0 ? 1 : 0;
send = true;

} else if((classes&RawInputEvent.CLASS_MOUSE) != 0) {

di.mAbs.changed = true;
di.mAbs.mNextNumPointers = (ev.value != 0) ? 1 : 2;
send = true;

}

i. In order to maintain the current coordinates of the cursor, change:

if (ev.type == RawInputEvent.EV_REL &&

(classes&RawInputEvent.CLASS_TRACKBALL) != 0) {
//Add this relative movement into our totals,
if (ev.scancode == RawInputEvent.REL_X) {

di.mRel.changed = true;
di.mRel.mNextData[MotionEvent.SAMPLE_X] += ev.value;

} else if (ev.scancode == RawInputEvent.REL_Y) {

di.mRel.changed = true;
di.mRel.mNextData[MotionEvent.SAMPLE_Y] += ev.value;

}
}

to:

```
if (ev.type == RawInputEvent.EV_REL) {
if ((classes&RawInputEvent.CLASS_TRACKBALL) != 0) {
  //Add this relative movement into our totals.
  if (ev.scancode == RawInputEvent,REL_X) {
```

di.mRel.changed = true;
di.mRel.mNextData[MotionEvent.SAMPLE_X] += ev.value;

} else if (ev.scancode == RawInputEvent.REL_Y) {

di.mRel.changed = true;
di.mRel.mNextData[MotionEvent.SAMPLE_Y] += ev.value;

```
  }
} else if ((classes&RawInputEvent.CLASS_MOUSE) != 0) {
  int dispW = mDisplayWidth, dispH = mDisplayHeight;
  if (mDisplay != null) {
```

if (mDisplay.getRotation( ) == Surface.ROTATION_90 ∥

mDisplay.getRotation( ) == Surface.ROTATION_270) {

```
  dispW = mDisplayHeight;
  dispH = mDisplayWidth;
}
```

```
  }
  if (ev.scancode == RawInputEvent.REL_X) {
```

```
di.mAbs.changed = true;
mCx += (int)ev.value;
if (mCx < 0)
  mCx = 0;
else if (mCx >= dispW)
  mCx = dispW − 1;
di.mAbs.mNextData[MotionEvent.SAMPLE_X] = mCx;
```

} else if (ev.scancode == RawInputEvent.REL_Y) {

```
di.mAbs.changed = true;
mCy += (int) ev.value;
if (mCy < 0)
  mCy = 0;
else if (mCy >= dispH)
  mCy = dispH − 1;
di.mAbs.mNextData[MotionEvent.SAMPLE_Y] = mCy;
```

}
}

j. Also, change:

addLocked(di, curTimeNano, ev.flags,

RawInputEvent.CLASS_TOUCHSCREEN, me);

### To:

if ((classes & RawInputEvent.CLASS_TOUCHSCREEN) != 0) {

addLocked(di, curTime, ev.flags,

RawInputEvent.CLASS_TOUCHSCREEN, me);

} else if ((classes & RawInputEvent.CLASS_MOUSE) != 0) {

addLocked(di, curTime, ev.flags,

RawInputEvent.CLASS_MOUSE, me);

}

k. Add the following method, which returns a new meta state for the specified mouse event (the meta indicates which mouse button was pressed):

private static final int makeMouseMetaState(RawInputEvent event) {

int mask;
switch (event.scancode) {

case RawInputEvent.BTN_LEFT:

mask = KeyEvent.META_MOUSE_EVENT;
break;

case RawInputEvent.BTN_RIGHT:

mask =
KeyEvent.META_MOUSE_RIGHT_BUTTON_EVENT;
break;

default:

Slog.w(TAG, “unsupported mouse button: ”

+ event.scancode);

mask = KeyEvent.META_MOUSE_EVENT;
break;

}
return mask;

}

### Clause 5:

a. In order to enable dispatching of mouse events, in: com.android.server.WindowManagerService.InputDispatcherThread.process( ) method, change:

if (ev.classType == RawInputEvent.CLASS_TOUCHSCREEN) {
to :
if (ev.classType == RawInputEvent.CLASS_TOUCHSCREEN

∥ ev.classType == RawInputEvent.CLASS_MOUSE) {

### Clause 6:

com.android.server.WindowManagerService Modifications:
a. Add fields:

private boolean mMouseCursorEnabled;

private int mCursorX = −1;
private int mCursorY = −1;
private int mMouseSurfaceSize;
private int mCursorType = 0;
//local coordinates of the mouse cursor hotspot
//(relative to the mouse surface)
//for example, the head of the arrow cursor
private final Point mCursorHotSpot = new Point(0,0);
private Surface mMouseSurface = null;
private boolean mCursorShown

b. Add method for creating/destroying/hiding/showing the mouse cursor surface:

final void updateMouseSurface(boolean enabled) {

mMouseCursorEnabled = enabled;
if (enabled && mMouseSurface == null) {
if(mCursorX == −1) {

```
mCursorX =
  (mDisplay.getWidth( ) − mMouseSurfaceSize) / 2;
mCursorY=
  (mDisplay.getHeight( ) − mMouseSurfaceSize) / 2;
```

```
  }
  try {
```

```
//First Mouse event, create Surface
if (mMouseSurface == null) {
  //had memory issues with width and height,those work
  and it changes anyway
  //when updateMouseCursorType( ) is called after it
  mMouseSurface =
```

```
new Surface(mFxSession,
  0, −1, mMouseSurfaceSize, mMouseSurfaceSize,
  PixelFormat.TRANSPARENT,
  Surface.FX_SURFACE_NORMAL);
```

updateMouseCursorType(0);
}

} catch (Exception e) {

Log.e(TAG,

″Unhandled exception creating mouse “+

”surface and updating cursor type″,e);

```
  }
} else if (!enabled && mMouseSurface != null) {
  mMouseSurface.release( );
  mMouseSurface = null;
}
```

}

c. Add to the constructor the reading of the mouse surface size:

mMouseSurfaceSize =

context.getResources( ).getDimensionPixelSize(value);

Where “value” is the desired size of the cursor.

In order to modify the cursor's appearance when the global configuration object changes:

d. In computeNewConfigurationLocked method, add, before the return statement:

adjustConfigurationLocked(config);

e. And add the following method to hide/show the mouse surface according to the global configuration object:

private final void adjustConfigurationLocked(Configuration config) {

updateMouseSurface(config.mouse ==
Configuration.MOUSE_STANDARD);

}

f. Add the following methods for requesting and setting the cursor type (shape):

```
  private void dispatchRequestCursorType(MotionEvent ev, intpid, int
  uid) {
```

```
synchronized (mWindowMap) {
  WindowState target = getFocusedWindowLocked( );
  if (target != null && target.mClient != null) {
    try {
```

target.mClient.disptachCursorTypeRequest(ev.getX( ),
ev.getY( ));

} catch (RemoteException e) {

Log.e(“WindowManagerService”, “unable to dispatch
cursor type request”,

e);

}

}
}

}

g. And to the internal class, Session for interacting with a window of an app:

public void setCursorType(int cursorType) {

synchronized (mWindowMap) {

if (mCursorType != cursorType) {

try {

updateMouseCursorType(cursorType);

mCursorType = cursorType;

} catch (RuntimeException e) {

Log.e(TAG, “Unhandled exception when
changing cursor”);

}

}

}

Add mouse event dispatching, cursor type query trigger and mouse cursor position updating to WindowManagerService.InputDispatcherThread.process( ), before “case RawInputEvent.CLASS_TOUCHSCREEN”:

case RawInputEvent.CLASS_MOUSE:

if (mMouseCursorEnabled) {

MotionEvent mmev = (MotionEvent)ev.event;
synchronized (mWindowMap) {

int newX = (int)mmev.getX( );
int newY= (int)mmev.getY( );
if(DEBUG_MOUSE)

Log.i(TAG, “moving mouse ” +
mMouseSurface + “ action ”
+ mmev.getAction( ) + “ lx ” + mCursorX
+ “ ly ” + mCursorY+ “ nx ” + newX + “ ny ” +
newY);

//if current mouse position is different than the one in
the event
if (mMouseSurface != null &&

(mCursorX != newX ∥ mCursorY != newY)) {

updateMouseCursorPosition(newX,

newY, mCursorHotSpot);

}

}
//call this before dispatchPointer( ),

//because dispatchPointer( ) recycles the event

dispatchRequestCursorType(mmev, 0, 0);

}

### Clause 7:

a. Add to android/view/IWindow.aidl a method declaration for sending cursor type query requests to windows:

void disptachCursorTypeRequest(float x, float y);

### Clause 8:

a. Add to android/view/IWindowSession.aidl a method declaration for setting the current cursor type:

void setCursorType(int cursorType);

### Clause 9:

a. To enable dispatching of cursor type query request, add to android.view.ViewRoot:

```
public final static int DISPATCH_CURSOR_TYPE_REQUEST = 1062;
  add to the handleMessage method, above “case
  DISPATCH_POINTER: {“:
    case DISPATCH_CURSOR_TYPE_REQUEST:
```

| float[ ] coordinates = (float[ ])msg.obj; | |
|---|---|
| if (mView != null && mAdded) { | |
| int cursorType = mView.dispatchGetCursorType(coordinates[0], | |
| coordinates[1]); | |
| try { | |
| | sWindowSession.setCursorType(cursorType); |
| } catch (RemoteException remoteEx) { | |
| | Log.e(″ViewRoot″, ″unable to set cursor type″, remoteEx); |

}
}
break;

the following method:

public void dispatchCursorTypeRequest(float x, float y) {

```
Message msg = Message.obtain( );
  msg.what = DISPATCH_CURSOR_TYPE_REQUEST;
  msg.obj = new float[ ] {x, y};
  sendMessage(msg);
```

}

b. Also, add another method to the inner class W, for the Iwindow.Stub implementation:

```
  public void disptachCursorTypeRequest(float x, float y) {
      final ViewRoot viewRoot = mViewRoot.get( );
  if (viewRoot != null) {
    viewRoot.disptachCursorTypeRequest(x, y);
  }
}
```

### Clause 10:

a. Add to android.view.ViewRoot: a helper flag for secondary button click (right mouse click): boolean mEatPointerEvents;
b. Add a message constant:

private static final int GENERATED_RIGHT_CLICK_UP = 2111;

c. In order to enable secondary button support, replace the contents of “case DISPATCH_POINTER” clause with the following code, which tries to dispatch an event for a secondary click (dispatchMouseRightClickEvent), and emulates a long click (on touch screen) if the event wasn't handled:

```
MotionEvent event = (MotionEvent)msg.obj;
      boolean callWhenDone = msg.arg1 != 0;
      if (event == null) {
        try {
          long timeBeforeGettingEvents;
          if (MEASURE_LATENCY) {
            timeBeforeGettingEvents = System.nanoTime( );
          }
          event = sWindowSession.getPendingPointerMove(mWindow);
        } catch (RemoteException e) {
        }
        callWhenDone = false;
      }
      if (event != null && mTranslator != null) {
        mTranslator.translateEventInScreenToAppWindow(event);
      }
      try {
        boolean handled = false;
        // eat events between right click down and the generated up event
        if (mView != null && mAdded && event != null
            && (!mEatPointerEvents || msg.arg1 == GENERATED_RIGHT_CLICK_UP)) {
          // enter touch mode on the down
          boolean isDown = event.getAction( ) == MotionEvent.ACTION_DOWN;
          if (isDown) {
            ensureTouchMode(true);
          }
          if(Config.LOGV) {
            captureMotionLog(“captureDispatchPointer”, event);
          }
          if (mCurScrollY != 0) {
                event.offsetLocation(0, mCurScrollY);
          }
          if (msg.arg1 != GENERATED_RIGHT_CLICK_UP
            && event.isMouseRightClickEvent( )) {
          // Try to dispatch a mouse right click event,
        //if not handled, simulate
          // long click by dispatching the
        // down and generating a delayed release(up).
          // Eat up/move/cancel events since
        //we generate our own delayed up event
          if (mView.dispatchMouseRightClickEvent(event)
        || !isDown) {
            handled = true;
          } else {
            MotionEvent upEvent = MotionEvent.obtain(event);
            upEvent.setAction(MotionEvent.ACTION_UP);
            Message upMsg = obtainMessage(DISPATCH_POINTER);
            upMsg.obj = upEvent;
            upMsg.arg1 = GENERATED_RIGHT_CLICK_UP;
            mEatPointerEvents = true;
            int pressLength = ViewConfiguration.getTapTimeout( )
              + ViewConfiguration.getLongPressTimeout( )
              + ViewConfiguration.
                  getEmulatedLongPressExtraTimeout( );
            sendMessageDelayed(upMsg, pressLength);
          }
        }
        if (!handled) {
          handled = mView.dispatchTouchEvent(event);
      }
      if (!handled && isDown) {
        int edgeSlop = mViewConfiguration.getScaledEdgeSlop( );
        final int edgeFlags = event.getEdgeFlags( );
        int direction = View.FOCUS_UP;
        int x = (int)event.getX( );
        int y = (int)event.getY( );
        final int[ ] deltas = new int[2];
        if ((edgeFlags & MotionEvent.EDGE_TOP) != 0) {
          direction = View.FOCUS_DOWN;
          if ((edgeFlags & MotionEvent.EDGE_LEFT) != 0) {
            deltas[0] = edgeSlop;
            x += edgeSlop;
          } else if ((edgeFlags &
            MotionEvent.EDGE_RIGHT) != 0) {
            deltas[0] = −edgeSlop;
            x −= edgeSlop;
          }
        } else if ((edgeFlags & MotionEvent.EDGE_BOTTOM) != 0) {
          direction = View.FOCUS_UP;
          if ((edgeFlags & MotionEvent.EDGE_LEFT) != 0) {
            deltas[0] = edgeSlop;
            x += edgeSlop;
          } else if ((edgeFlags & MotionEvent.EDGE_RIGHT) != 0) {
            deltas[0] = −edgeSlop;
            x −= edgeSlop;
          }
        } else if ((edgeFlags & MotionEvent.EDGE_LEFT) != 0) {
          direction = View.FOCUS_RIGHT;
        } else if ((edgeFlags & MotionEvent.EDGE_RIGHT) != 0) {
          direction = View.FOCUS_LEFT;
            }
            if (edgeFlags != 0 && mView instanceof ViewGroup) {
              View nearest =
                FocusFinder.getInstance( ).findNearestTouchable(
                  ((ViewGroup) mView), x, y, direction, deltas);
              if (nearest != null) {
                event.offsetLocation(deltas[0], deltas[1]);
                event.setEdgeFlags(0);
                mView.dispatchTouchEvent(event);
              }
            }
          }
        }
      } finally {
        //after the generated right click up
      //is recieved, we can continue accepting events
        if (msg.arg1 == GENERATED_RIGHT_CLICK_UP) {
          mEatPointerEvents = false;
        }
        if (callWhenDone) {
          try {
            sWindowSession.finishKey(mWindow);
          } catch (RemoteException e) {
          }
        }
        if (event != null) {
          event.recycle( );
        }
        // Let the exception fall through -- the looper will catch
        // it and take care of the bad app.
      }
```

### Clause 11:

a. In order to allow dispatching of cursor type query throughout the UI control hierarchy:
b. Add new methods with default implementation to the base UI control class, android.view.View:

```
/**
    * @hide
    */
  public int dispatchGetCursorType(float x, float y) {
    return getCursorType( );
  }
    /**
    * @hide
    */
  protected int getCursorType( ) {
    return 0;
  }
```

c. Also, add to the base UI control container class, android.view.ViewGroup, with implementation for dispatching to its child controls according to the event coordinates and the child control rectangle:

```
/**
* {@inheritDoc}
* @hide
*/
@Override
public int dispatchGetCursorType(float x, float y) {
  // Find a child located in the specified
  // coordinates and get the cursor type from it
  final Rect frame = mTempRect;
  final float scrolledXFloat = x + mScrollX;
  final float scrolledYFloat = y + mScrollY;
  final int scrolledXInt = (int) scrolledXFloat;
  final int scrolledYInt = (int) scrolledYFloat;
  final View[ ] children = mChildren;
  final int count = mChildrenCount;
  int cursorType = −1;
  boolean foundIntersectingChild = false;
        for (int i = count − 1; i >= 0; i−−) {
    final View child = children[i];
    if ((child.mViewFlags & VISIBILITY_MASK) == VISIBLE
        || child.getAnimation( ) != null) {
      child.getHitRect(frame);
      if (frame.contains(scrolledXInt, scrolledYInt)) {
        final float xc = scrolledXFloat − child.mLeft;
        final float yc = scrolledYFloat − child.mTop;
        cursorType = child.dispatchGetCursorType(xc, yc);
        foundIntersectingChild = true;
        if (DBG) {
              Log.d(“ViewGroup”, “found target”);
        }
        break;
      }
    }
  }
  if (!foundIntersectingChild) {
        cursorType = getCursorType( );
  }
  return cursorType;
}
```

d. In order to display a different cursor for controls which allows to edit text, add the following method override to android.widget.EditText control class which returns a different cursor type which suits this control:

/**
* {@hide}
*/
@Override
protected int getCursorType( ) {
return 1;
}

### Clause 12:

To allow dispatching of secondary button click throughout the UI controlls hirerarchy:

a. Add the following to the base UI control class, android.view.View:

```
  /**
  * @hide
  */
public boolean dispatchMouseRightClickEvent(MotionEvent event) {
  return onMouseRightClickEvent(event);
}
/**
* @hide
*/
protected boolean onMouseRightClickEvent(MotionEvent event) {
  return false;
}
```

b. Also, add, to the base UI container class, android.view.ViewGroup:

```
/**
* {@inheritDoc}
    * @hide
*/
@Override
public boolean dispatchMouseRightClickEvent(MotionEvent ev) {
  final float x = ev.getX( );
  final float y = ev.getY( );
  final Rect frame = mTempRect;
  final float scrolledXFloat = x + mScrollX;
  final float scrolledYFloat = y + mScrollY;
  final int scrolledXInt = (int) scrolledXFloat;
  final int scrolledYInt = (int) scrolledYFloat;
  final View[ ] children = mChildren;
  final int count = mChildrenCount;
  boolean handled = false;
  for (int i = count − 1; i >= 0; i−−) {
    final View child = children[i];
    if ((child.mViewFlags & VISIBILITY_MASK) == VISIBLE
        || child.getAnimation( ) != null) {
      child.getHitRect(frame);
      if (frame.contains(scrolledXInt, scrolledYInt)) {
        final float xc = scrolledXFloat − child.mLeft;
        final float yc = scrolledYFloat − child.mTop;
        ev.setLocation(xc, yc);
        handled = child.dispatchMouseRightClickEvent(ev);
        if (DBG) {
          Log.d(“ViewGroup”, “found target”);
        }
        break;
      }
    }
  }
  if (!handled) {
    ev.setLocation(x, y);
    handled = super.dispatchMouseRightClickEvent(ev);
  }
  return handled;
}
```

### Clause 13:

a. Add cursor images to the frameworks/base/core/res/res/drawable folder: with the names cursor.png, handpointer.png, arrow.png

### Clause 14:

b. Add helper methods for querying the mouse meta data to android.view.MotionEvent:

```
  /**
  * @hide
  */
public final boolean isMouseEvent( ) {
  return (mMetaState & KeyEvent.META_MOUSE_EVENT) != 0;
}
/**
  * @hide
  */
public final boolean isMouseRightClickEvent( ) {
  return (mMetaState &
  KeyEvent.META_MOUSE_RIGHT_BUTTON_EVENT) != 0;
}
```

### Clause 15:

a. Add constant and helper method for long press emulation in android.view.ViewConfiguration:

```
  /**
  * Defines the duration in milliseconds added to a long press emulation
  * calculation (tap timeout + long press timeout + emulated long
  * press extra timeout) in order to increase compatibility probability with
  * long press implementations in 3rd party Views.
  */
private static final int
EMULATED_LONG_PRESS_EXTRA_TIMEOUT = 250;
/**
* @return the duration in milliseconds added to a long press emulation
* calculation (tap timeout + long press timeout + emulated long
* press extra timeout) in order to increase compatibility probability with
* long press implementations in 3rd party Views.
  * @hide
*/
public static int getEmulatedLongPressExtraTimeout( ) {
  return EMULATED_LONG_PRESS_EXTRA_TIMEOUT;
}
```

### Clause 16:

### Enable Task Removal for Task Bar Support:

a. Add to android.app.ActivityManager:

```
  /**
  * Removes the task from the recent task list
  * @hide
  */
  public void removeRecentTask(int taskId) {
    try {
      ActivityManagerNative.getDefault( ).removeRecentTask(taskId);
    } catch (RemoteException e) {
    }
  }
Add to android.app.ActivityManagerProxy:
    /**
    * @hide
    */
  public void removeRecentTask(int taskId) throws RemoteException
  {
    Parcel data = Parcel.obtain( );
    Parcel reply = Parcel.obtain( );
    data.writeInterfaceToken(IActivityManager.descriptor);
    data.writeInt(taskId);
    mRemote.transact(
    REMOVE_RECENT_TASK_TRANSACTION, data, reply, 0);
    reply.readException( );
  data.recycle( );
  reply.recycle( );
}
```

b. Add to android.app.ActivityManagerNative.on Transact method, in the switch statement:

```
case REMOVE_RECENT_TASK_TRANSACTION: {
  data.enforceInterface(IActivityManager.descriptor);
  int taskId = data.readInt( );
  removeRecentTask(taskId);
  reply.writeNoException( );
  return true;
}
```

c. Add to android.app.IActivityManager:

```
    /**
    * @hide
    */
  public void removeRecentTask(int taskId) throws RemoteException;
int REMOVE_RECENT_TASK_TRANSACTION =
Ibinder.FIRST_CALL_TRANSACTION+350;
```

### Clause 17:

a. Add a task bar:
TaskBarView class, which is the UI element of the taskbar:

```
package com.android.server.status;
    import android.content.Context;
    import android.content.Intent;
    import android.util.AttributeSet;
    import android.util.Log;
    import android.view.KeyEvent;
    import android.view.MotionEvent;
    import android.view.View;
    import android.view.ViewGroup;
    import android.view.ViewParent;
    import android.view.View.OnClickListener;
    import android.widget.FrameLayout;
    import android.widget.LinearLayout;
    import com.android.internal.R;
    public class TaskBarView extends LinearLayout {
      private static final String TAG = “StatusBarView”;
      public TaskBarView(Context context, AttributeSet attrs) {
        super(context, attrs);
      }
    }
    task_bar.xml layout for the TaskBarView control:
    <?xml version=“1.0” encoding=“utf-8”?>
    <com.android.server.status.TaskBarView
    xmlns:android=“http://schemas.android.com/apk/res/android”
      android:orientation=“horizontal”
      android:background=“@drawable/task_bar_background”
      android:focusable=“true” android:focusableInTouchMode=“true”
      >
      <LinearLayout android:id=“@+id/tasks”
        android:layout_width=“wrap_content”
        android:layout_weight=“1”
        android:layout_height=“fill_parent”
        android:orientation=“horizontal”/>
      <LinearLayout android:id=“@+id/icons”
        android:layout_width=“wrap_content”
      android:layout_height=“fill_parent”
      android:orientation=“horizontal”
        android:layout_gravity=“right”
        android:gravity=“center_vertical”>
              <TextView android:layout_width=“wrap_content”
                android:layout_height=“wrap_content”
                style=“@android:style/TaskbarIcon”
                  android:layout_marginRight=“3px”
                  android:id=“@+id/home”
                android:background=
              “@drawable/btn_taskbar_home” />
                <TextView android:layout_width=“wrap_content”
                android:layout_height=“wrap_content”
                  style=“@android:style/TaskbarIcon”
              android:layout_gravity=“center_vertical”
                android:id=“@+id/menu”
                android:background=
              “@drawable/btn_taskbar_menu”
                />
                <TextView android:layout_width=“wrap_content”
                android:layout_height=“wrap_content”
                  android:layout_marginLeft=“3px”
                style=“@android:style/TaskbarIcon”
                  android:id=“@+id/back”
                android:background=
              “@drawable/btn_taskbar_back” />
                  <TextView android:layout_width=“wrap_content”
                  android:layout_height=“wrap_content”
                  android:layout_marginLeft=“3px”
                  style=“@android:style/TaskbarIcon”
                    android:id=“@+id/search”
                    android:background=
                    “@drawable/btn_taskbar_search” />
      </LinearLayout>
      </com.android.server.status.TaskBarView>
```

b. Provide task_bar_icon.xml layout for the application's icons:

```
<?xml version=“1.0” encoding=“utf-8”?>
<TextView
  xmlns:android=“http://schemas.android.com/apk/res/android”
  android:id=“@+id/label”
  style=“?android:attr/buttonStyle”
  android:layout_width=“wrap_content”
  android:layout_height=“30px”
  android:minWidth=“80px”
  android:textColor=“@color/primary_text_dark_focused”
  android:background=“@drawable/btn_taskbar_icon_selector”
  android:paddingTop=“2px”
  android:paddingBottom=“2px”
  android:paddingRight=“4px”
  android:layout_marginRight=“1px”
  android:drawablePadding=“0px”
  android:textSize=“12px”
  android:maxLines=“1”
  android:ellipsize=“marquee”
  android:fadingEdge=“horizontal”
  android:gravity=“left\center_vertical” />
```

c. Provide taskbarvirtualbutton.xml for the virtual hardware buttons:

<?xml version=“1.0” encoding=“utf-8”?>
<TextView xmlns:android=“http://schemas.android.com/apk/res/android”

android:layout_width=“wrap_content”
android:layout_height=“wrap_content”
android:layout_marginLeft=“1px”

android:layout_marginRight=“1px”

/>

Provide TaskBarService which manages the task bar. The task bar displays the current tasks running, allows switching between them, and closing them. In order to resume or stop a specific task the task bar uses calls to the ActivityManagaerService:

d. Add an android AIDL file for generating an IPC interface for the taskbar:

package android.app;
import android.content.ComponentName;
import android.content.Intent;
/** @hide */
oneway interface ITaskBar
{

void taskAdded(int id, in Intent baseIntent,

String origActivityClassName,
String origActivityPackageName, int replacedTaskId);

void setEnabled(boolean enabled);

}

e. Add service name constant to android.content.Context:

public static final String TASK_BAR_SERVICE = “taskbar”;

f. Add window type constant to android.view.WindowManager:

public static final int TYPE_TASK_BAR =

FIRST_SYSTEM_WINDOW+250;

g. Add code for starting the task bar service to com.android.server.SystemServer:
h. Add to the “run” method (initializing):

TaskBarService taskBarService = null;

i. After Slog.e (TAG, “Failure starting Wallpaper Service”, e);} to instantiate the service add:

try {

Slog.i(TAG, “TaskBarService.”);
taskBarService = new TaskBarService(context);
ServiceManager.addService(Context.TASK_BAR_SERVICE,
taskBarService);

} catch (Throwable e) {

Slog.e(TAG, “Failure starting Task Bar Service”, e);

}

j. And, after “tatusBar.systemReady( )}”, to initialize the service, add:

if (taskBarService != null) {

taskBarService.systemReady( );

}

k. Modify activity and window management modules in order to support the taskbar: corn.android.server.ActivityManagerService class:
l. Modify the addRecentTaskLocked method to ignore replacement of existing tasks:

```
private final void addRecentTaskLocked(TaskRecord task) {
        // Remove any existing entries that are the same kind of task.
        int N = mRecentTasks.size( );
        boolean replacedOtherTask = false;
        for (int i=0; i<N; i++) {
          TaskRecord tr = mRecentTasks.get(i);
          if ((task.affinity != null && task.affinity.equals(tr.affinity))
              || (task.intent != null &&
              task.intent.filterEquals(tr.intent))) {
            mRecentTasks.remove(i);
            i−−;
            N−−;
            if (task.intent == null) {
              // If the new recent task we are adding is not fully
              // specified, then replace
      //it with the existing recent task.
        task = tr;
      }
      //we call that for every replaced task,
      //only ones that can be found will be replaced
      recentTaskAdded(task, tr.taskId);
      replacedOtherTask = true;
    }
  }
  if (N >= MAX_RECENT_TASKS) {
    mRecentTasks.remove(N−1);
  }
  mRecentTasks.add(0, task);
  if (!replacedOtherTask) {//if we didn't replace any, just add
    recentTaskAdded(task, −1);
  }
}
```

m. And add the following methods to support removal of tasks and to notify the task bar when tasks are added:

```
public void recentTaskAdded(TaskRecord task, int removedTaskId) {
        if ((task.intent == null)
          || ((task.intent.getFlags( )
              &Intent.-
              FLAG_ACTIVITY_EXCLUDE_FROM_RECENTS)
        == 0)) {
          ITaskBar taskBar =
            ItaskBar.Stub.asInterface(
              ServiceManager.-
              getService(Context.TASK_BAR_SERVICE));
    if (taskBar != null) {
      Intent baseIntent =
    new Intent(task.intent != null ? task.intent : task.affinityIntent);
        try {
          taskBar.taskAdded(task.taskId, baseIntent,
                task.origActivity != null ?
              task.origActivity.getClassName( ) : null,
                  task.origActivity != null ?
              task.origActivity.getPackageName( ) : null,
                removedTaskId);
        } catch (RemoteException e) {
          Log.e(TAG, “Error while calling taskAdded”, e);
    }
    }
  }
}
  //searches and removes the specified task
public void removeRecentTask(int taskId) {
  int N = mRecentTasks.size( );
  for (int i=0; i<N; i++) {
    TaskRecord task= mRecentTasks.get(i);
    if (task.taskId == taskId) {
      mRecentTasks.remove(i);
      break;
    }
  }
}
```

n. When detecting a change of configuration which indicates a change in use case (mouse is being used for example), the task bar may be shown and hidden by calling its setEnabled method.

Modify com.android.internal.policy.impl.PhoneWindowManager in order to support the window of the task bar:

o. Add task bar layer constant and increase the preceding layer constants values by 1 in order to allow the layer of the taskbar to appear above other layers:

```
static final int TASK_BAR_LAYER = 9;
Add fields:
WindowState mTaskBar = null;
boolean mForceTaskBar;
Add to the windowTypeToLayerLw method swich statement:
case TYPE_TASK_BAR:
  return TASK_BAR_LAYER;
Add to the canBeForceHidden method:
&& attrs.type != WindowManager.LayoutParams.TYPE_TASK_BAR;
Add to the switch statement in the prepareAddWindowLw method:
case TYPE_TASK_BAR:
          if (mTaskBar != null) {
            return
            WindowManagerImpl.ADD_MULTIPLE_SINGLETON;
          }
          mTaskBar = win;
          break;
```

p. Add to the removeWindowLw method, at the beginning:

```
if (mTaskBar == win) {
          mTaskBar = null;
        }
```

q. In the finishAnimationLw method, replace:

“if (mStatusBar != null) {“

With

“if (mStatusBar != null || mTaskBar != null) {“

In the beginLayoutLw method:

r. Add the following code at the end of the if statement scope to set the screen area bottom position to be above the task bar:

```
// decide here what will be the bottom y coordinate for the rest of the
    // windows before we start the layout process. even that we
    // might reserver place here for the taskbar, we might hide it in
    // later layout stages in case of fullscreen mode.
    if (mTaskBar != null && !mKeyguardMediator.isShowing( )) {
      mTaskBar.computeFrameLw(pf, df, vf, vf);
      if (mTaskBar.isVisibleLw( )) {
        // If the status bar is hidden, we do not want to cause
        // windows behind it to scroll.
        mDockBottom = mContentBottom =
        mCurBottom = mTaskBar.getFrameLw( ).top;
            + mContentBottom + “ mCurBottom=” + mCurBottom);
      }
    }
```

s. Modify the layoutWindowLw method to allow hiding of taskbar in fullscreen mode:

```
change if (win == mStatusBar) { to if (win == mStatusBar ||
win == mTaskBar) {
Modify the finishAnimationLw method:
after boolean hiding = false;, add:
if (mTaskBar != null) {
        if (mForceTaskBar) {
          if (DEBUG_LAYOUT) Log.v(TAG, “Showing task bar”);
          if (mTaskBar.showLw(true))
      changes |= FINISH_LAYOUT_REDO_LAYOUT;
        } else if (mTopFullscreenOpaqueWindowState != null) {
      WindowManager.LayoutParams lp =
        mTopFullscreenOpaqueWindowState.getAttrs( );
      boolean hideTaskBar =
        (lp.flags &
        WindowManager.LayoutParams.FLAG_FULLSCREEN) != 0
        || mKeyguardMediator.isShowing( );
      if (hideTaskBar) {
        if (DEBUG_LAYOUT) Log.v(TAG, “Hiding task bar”);
          if (mTaskBar.hideLw(true))
  changes |= FINISH_LAYOUT_REDO_LAYOUT;
      } else {
        if (DEBUG_LAYOUT) Log.v(TAG, “Showing task bar”);
        if (mTaskBar.showLw(true))
  changes |= FINISH_LAYOUT_REDO_LAYOUT;
      }
    }
  }
```

### Clause 18:

Add text selection logic for mouse:

a. Add the following method to android.text.method.ArrowKeyMovement to select part of the text when dragging the mouse (ACTION_MOVE) and to set the selection start position when pressing the mouse left button (ACTION_DOWN):

```
/**
    * @hide
    */
  public boolean onMouseEvent(TextView widget, Spannable buffer,
      MotionEvent event) {
    boolean handled = false;
    int x = (int) event.getX( );
    int y = (int) event.getY( );
    int off = getOffset(x, y, widget);
    int action = event.getAction( );
    switch (action) {
    case MotionEvent.ACTION_MOVE:
      // XXX may do the same adjust for x as we do for the line.
      boolean cap = (MetaKeyKeyListener.getMetaState(buffer,
          KeyEvent.META_SHIFT_ON) == 1)
          || (MetaKeyKeyListener.getMetaState(buffer,
            MetaKeyKeyListener.META_SELECTING) != 0);
      if (cap) {
        Selection.extendSelection(buffer, off);
      } else {
        Selection.setSelection(buffer, off);
      }
      MetaKeyKeyListener.adjustMetaAfterKeypress(buffer);
      MetaKeyKeyListener.resetLockedMeta(buffer);
      handled = true;
      break;
    case MotionEvent.ACTION_DOWN:
//locating the cursor in the clicked location
      Selection.setSelection(buffer, off);
      widget.cancelLongPress( );
    }
    return handled;
}
```

And integrate the mouse text selection into the text editing control by modifying android.widget.TextView:

b. Add the following method to show context menu for right mouse button click, and use ArrowKeyMovementMethod to manage the selection on other mouse events:

```
private boolean onMouseEvent(MotionEvent event) {
    int action = event.getAction( );
    if (event.getPressure( ) == 0) {
      //for right click: show context menu on DOWN or eat the event
      if (action == MotionEvent.ACTION_DOWN) {
        showContextMenu( );
      }
      return true;
    }
    if (action == MotionEvent.ACTION_DOWN) {
      // Reset this state; it will be re-set if super.onTouchEvent
      // causes focus to move to the view.
      mTouchFocusSelected = false;
      mScrolled = false;
    }
    final boolean superResult =
    super.onTouchEvent(event);
    switch (action) {
    case MotionEvent.ACTION_DOWN:
      if (mMovement != null
    && mMovement instanceof ArrowKeyMovementMethod) {
      MetaKeyKeyListener.stopSelecting(this, (Spannable) mText);
      ((ArrowKeyMovementMethod)mMovement)
        .onMouseEvent(this, (Spannable) mText, event);
    }
    break;
  case MotionEvent.ACTION_MOVE:
    if (MetaKeyKeyListener.getMetaState(
        mText, MetaKeyKeyListener.META_SELECTING) == 0) {
      MetaKeyKeyListener.startSelecting(this, (Spannable) mText);
    } else if (mMovement != null &&
        mMovement instanceof ArrowKeyMovementMethod) {
      ((ArrowKeyMovementMethod)mMovement).
        onMouseEvent(this, (Spannable) mText, event);
    }
    break;
  case MotionEvent.ACTION_UP:
    int selectionStart = Selection.getSelectionStart(mText);
    int selectionEnd = Selection.getSelectionEnd(mText);
    if (selectionStart == selectionEnd) {
      //stop selecting in this case because a selection pointer
      //is visible when in selection mode and there's no selection
      MetaKeyKeyListener.stopSelecting(this, (Spannable) mText);
    }
    break;
  }
  return true;
}
```

c. And integrate the above into the touch event dispatching by modifying the on TouchEvent method by
adding in the beginning:

if (event.isMouseEvent( ) && onCheckIsTextEditor( )) {
return onMouseEvent(event);
}

### Clause 19:

a. Add to android.view.View base methods for highlighting and a flag that indicates if highlighting takes place:

```
/**
  * @hide
  */
protected boolean isHighlighting( ) {
  return mAttachInfo == null ? false :mAttachInfo.mHighlighting;
}
/**
  * @hide
//default highlighting executes the internal method for focusing,
handleFocusGainInternal.
    */
  public boolean dispatchFocus(float x, float y) {
    boolean focused = false;
    if (isFocusable( )) {
      handleFocusGainInternal(View.FOCUS_DOWN, new Rect( ));
      focused = true;
    }
    return focused;
  }
and to its inner class AttachInfo, add:
    boolean mHighlighting;
```

Add to android.view.ViewRoot the dispatching of messages responsible for starting and slopping the highlighting:

```
public final static int DISPATCH_HIGHLIGHT = 1063;
public final static int FINISH_HIGHLIGHT = 1064;
/**
* @hide
* */
public void dispatchFocus(float x, float y) {
  Message msg = Message.obtain( );
  msg.what = DISPATCH_HIGHLIGHT;
  msg.obj = new float[ ] {x, y};
  sendMessage(msg);
}
/**
* @hide
* */
public void finishHighlight( ) {
  Message msg = Message.obtain( );
  msg.what = FINISH_HIGHLIGHT;
  sendMessage(msg);
}
```

b. To its handleMessage method switch statement, add:

```
case DISPATCH_HIGHLIGHT:
  coordinates = (float[ ])msg.obj;
  ensureTouchMode(false);
  mAttachInfo.mHighlighting = true;
  mView.dispatchFocus(coordinates[0], coordinates[1]);
  break;
case FINISH_HIGHLIGHT:
  ensureTouchMode(true);
//sets the flag off to indicate highlighting is stopped.
  mAttachInfo.mHighlighting = false;
  break;
```

c. Add to android.view.ViewRoot.W (dispatching):

```
public void dispatchHighlight(float x, float y)
throws RemoteException {
  final ViewRoot viewRoot = mViewRoot.get( );
  if (viewRoot != null) {
    viewRoot.dispatchFocus(x, y);
  }
}
public void finishHighlight( ) throws RemoteException {
  final ViewRoot viewRoot = mViewRoot.get( );
  if (viewRoot != null) {
    viewRoot.finishHighlight( );
  }
}
```

d. Add to android.view.ViewGroup in order to dispatch the focus through the UI control hierarchy by dispatching to the child which its rectangle intersects with the specified coordinates:

```
/**
  * {@inheritDoc}
  * @hide
  */
@Override
public boolean dispatchFocus(float x, float y) {
  final int descendantFocusability = getDescendantFocusability( );
  if (descendantFocusability == FOCUS_BLOCK_DESCENDANTS) {
    return super.dispatchFocus(x, y);
}
// Find a child located in the specified
//coordinates and get the cursor type from it
final Rect frame = mTempRect;
final float scrolledXFloat = x + mScrollX;
final float scrolledYFloat = y + mScrollY;
final int scrolledXInt = (int) scrolledXFloat;
final int scrolledYInt = (int) scrolledYFloat;
final View[ ] children = mChildren;
final int count = mChildrenCount;
int cursorType = −1;
boolean foundIntersectingFocusableChild = false;
      for (int i = count − 1; i >= 0; i−−) {
  final View child = children[i];
  if ((child.mViewFlags & VISIBILITY_MASK) == VISIBLE
      || child.getAnimation( ) != null) {
    child.getHitRect(frame);
    if (frame.contains(scrolledXInt, scrolledYInt) ){
      final float xc = scrolledXFloat − child.mLeft;
      final float yc = scrolledYFloat − child.mTop;
      foundIntersectingFocusableChild =
      child.dispatchFocus(xc, yc);
      if (foundIntersectingFocusableChild) {
        break;
      }
    }
  }
}
if (foundIntersectingFocusableChild) {
  return true;
  } else {
    return super.dispatchFocus(x, y);
  }
}
```

It is appreciated that the methods and systems shown and described herein may be applicable to operating systems which are not identical to Android but have relevant features in common therewith. For example, it is appreciated that the embodiments herein described as operating with an Android operating system may instead operate in accordance with any touch OS or any suitable operating system which supports a touch based user interface and does not support a cursor based user interface, such as Symbian, Blackberry, iOS, WindowsMobile.

It is appreciated that according to certain embodiments, the OS is modified not to accommodate only an individual HID or output device, but rather to accommodate selectable ones of a plurality of IO devices typically including any of a first plurality of HIDs such as but not limited to keyboard, mouse, trackball, touchpad, touchscreen, joystick, game pad, and any of a second plurality of output devices such as but not limited to TV, computer screen, LCD, car integrated screen, personal screen in airplanes, tread mill screen, tablet, laptop, netbook, optionally in accordance with more than one possible use case such as but not limited to productivity use case (smartphone or tablet connected to external keyboard, mouse, 19″ screen), smartphone or tablet connected to a TV and optionally a wireless keyboard, smartphone or tablet connected to tread mill.

To do this, typically, a designer decides which use cases and IO devices to support. Then some or all of the steps of the method of FIG. 2 are performed, as appropriate. During operation, the OS moves from IO device to IO device. It first recognizes each newly encountered IO device by handshaking. It is appreciated that conventional operating systems typically recognize standard USB HID devices, like keyboards and mice, without needing a special driver. Once the device has been recognized, the modified OS adjusts its behavior and appearance in order to allow optimized use with the detected IO devices. For example:

a. Smaller buttons/menus may be provided when the use-case involves a pointer based HID (such as mouse) instead of a touchscreen because a pointer is smaller than a finger area over a touchscreen,

b. Adding UI elements to utilize the added screen size/resolution of a larger screen if found to be available. Added UI elements may include but are not limited to an additional task bar, or software buttons replicating the function of physical buttons.

c. displaying a context aware pointer/cursor when a pointer based HID is connected.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

Features of the present invention which are described in the context of separate embodiments may also be provided in combination in a single embodiment. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

1. A computerized system for hopping between an existing population of I/O devices, each said I/O device being operative to communicate with operating systems in accordance with a respective I/O protocol, the system comprising:
a mobile operating system operative to execute at least one application by communicating with a selectable individual one of said existing population of I/O devices, including selectably interacting with the selectable individual I/O device in accordance with its respective I/O protocol, wherein the population of I/O devices from which said individual I/O device is selected includes a plurality of I/O devices including at least one I/O device which is not housed with the operating system; and
hardware within which said mobile operating system resides and interacting with said mobile operating system.

2. A system according to claim 1 wherein said mobile operating system comprises at least most functionalities of Android.

3. A system for selecting text displayed on a display device having a text display area, the system comprising:
an operating system including a touch-based text selection functionality recognizing inputs; and
an input device operative, responsive to user manipulation thereof, to point to locations within said text display area, the input device including a user interface accepting user manipulations,
and wherein the operating system includes a user manipulation translater translating said user manipulations into inputs recognized by said touch-based text selection functionality which, when recognized, cause said touch-based text selection functionality to select said locations.

4. A computerized system providing a context-aware pointer to a computerized display area serving at least one Android application, the system comprising: an Android operating system operative to display a hierarchy of Android views generated pursuant to said Android application;
an Android view interpreter identifying, at each point in time, at least one view feature characterizing at least one of said views; and
a context-aware cursor generator operative to generate, on said computerized display, a cursor having cursor characteristics which vary over time wherein, at a particular point in time, at least one of said cursor characteristics depends on said view feature identified at said particular point in time, for a location pointed to by said cursor at said point in time.

5. A system according to claim 4 wherein said views include at least one of a geometric shape, an icon, and a set of alphanumeric characters.

6. A system according to claim 4 wherein said Android operating system includes a hierarchy of display generators respectively operative to generate said hierarchy of Android views and wherein said Android view interpreter is operative to obtain information from said display generators, from which information said feature is derivable.

7. A system according to claim 4 wherein said view feature comprises whether or not said view includes at least one of a text, a link, button, text editing box, text box, drop down list, combo box, text, image, table, list, tab, radio button.

8. A system according to claim 4 wherein said feature comprises a cursor characteristic which the Android application has designated to represent an individual Android view.

9. A system according to claim 7 wherein said information comprises the feature itself.

10. A system according to claim 7 wherein said Android view interpreter is operative to obtain said information by asking said display generators what view to display.

11. A system according to claim 1 wherein said operating system supports a touch based user interface and does not support a cursor based user interface.

12. A system according to claim 2 wherein said system is operative to provide a context-aware pointer to a computerized display area serving at least one Android application;
and wherein said Android operating system is operative to display a hierarchy of Android views generated pursuant to said Android application;
and wherein said mobile operating system also comprises:
an Android view interpreter identifying, at each point in time, at least one view feature characterizing at least one of said views; and
a context-aware cursor generator operative to generate, on said computerized display, a cursor having cursor characteristics which vary over time wherein, at a particular point in time, at least one of said cursor characteristics depends on said view feature identified at said particular point in time, for a location pointed to by said cursor at said point in time.

13. A system according to claim 1 wherein said mobile operating system generates a user interface (UI) and wherein said system also comprises a UI adapting functionality operative for obtaining information characterizing an I/O device to which said operating system has been connected and for modifying said user interface accordingly.

14. A system according to claim 13 wherein said UI adapting functionality is operative, when at least one individual I/O device is connected to said operating system, to add a task-bar to said user interface including at least one tool useful in conjunction with said individual I/O device.

15. A system according to claim 14 wherein said task-bar is added if said individual I/O device is known to be larger than a threshold size.

16. A system according to claim 13 wherein said I/O device comprises an input device.

17. A system according to claim 13 wherein said I/O device comprises a display device.

18. A system according to claim 13 wherein said mobile operating system comprises a touch-based operating system operative to generate a display including at least one subregion which, if when coming into contact with a finger, triggers an operating system action, and wherein, if a cursor-based input device is connected to said operating system, said UI adapting functionality is operative to decrease said sub-region in size relative to the total area of the display.

19. A system according to claim 18 wherein said sub-region includes a button.

20. A system according to claim 3 wherein said user manipulation comprises pressing a button on the input device.

21. A system according to claim 3 wherein said user manipulation comprises dragging the input device.

22. A system according to claim 1 wherein said operating system supports a plurality of I/O protocols.

23. A system according to claim 1 wherein the operating system is operative to execute at least one application including:
recognizing an input device from among a plurality of known input devices including at least one input device which is not inherent to the operating system and executing said application based on interpreting at least one input from said recognized input device, including generating at least application output.

24. A system according to claim 23 wherein the operating system is operative for recognizing an output device from among a plurality of known output devices and outputting said application output based on at least one parameter of said recognized output device.

25. A system according to claim 23 wherein said recognized input device is the inherent input device of the operating system.

26. A system according to claim 1 and also comprising:
a client which receives input events and sends them to the operating system;
an interface to a selectable input device type from among a plurality of input device types;
an interface to a selectable output device type from among a plurality of output device types; and
an adaptor to adapt said interfaces to each other.

27. A system according to claim 13 wherein said IO device comprises a screen of a size comparable in size to a laptop screen.

28. A system according to claim 13 wherein said UI is operative to support at least one of keyboard input and mouse input, said UI being operative to provide at least one of the following:
i. Enabling hovering concept;
ii. Copy-Paste experience;
iii. Right click experience;
iv. Context aware cursor;
v. Text selection;
vi. Right mouse click functionality;
vii. PC oriented keyboard operation translation;
viii. Task bar;
ix. Scrolling by use of an external device;
x. Control of size and layout for mouse input.

29. A system according to claim 20 wherein said user manipulation comprises left-pressing a left mouse button over a selection start point, moving mouse to a selection end point and releasing the button and wherein responsively, a text extending from said start point to said end point is selected by said operating system.

30. A system according to claim 13 wherein said IO device comprises a PC keyboard and said modifying comprises adding support for at least one conventional PC oriented keyboard operation to said mobile operating system.

31. A system according to claim 30 wherein said keyboard operations include at least one of alt+tab, ctrl+c, and ctrl+v.

32. A system according to claim 13 wherein said IO device comprises an external scroll device.

33. A system according to claim 32 wherein said scroll device is from a group including a mouse scroll wheel and a touch pad.

34. A system according to claim 1 and wherein said application comprises at least one of the following applications: Internet surfing, music, video viewing, emailing, calendar maintenance, maps, at least one Android application such as GPS or maps, and voicecalls.

35. A system for input-device mediated scrolling, without touching a display area which is controlled by a touch-based cellular telephone operating system, the system comprising:
a control data injection point to a display control functionality in the touch-based operating system, the functionality being operative to display only a display area-sized portion of an image which is larger than said display area, responsive to sensed finger motions supplied via a finger-data injection point; and
an input device-mediated scrolling interpreter operative, responsive to user manipulation of a scrolling functionality of the input device, to inject to said display control functionality via said control data injection point, an indication of a display area-sized portion of the image to be displayed on the display area.

36. A system for input-device mediated scrolling, without touching a display area which is controlled by a touch-based Android operating system, the system comprising:
a control data injection point to a display control functionality in the touch-based Android operating system, the functionality being operative to display only a display area-sized portion of an image which is larger than said display area, responsive to sensed finger motions supplied via a finger-data injection point; and
an input device-mediated scrolling interpreter operative, responsive to user manipulation of a scrolling functionality of the input device, to inject to said display control functionality via said control data injection point, an indication of a display area-sized portion of the image to be displayed on the display area.

37. A system according to claim 35 wherein said display area is integrally formed with a mobile electronic device and wherein said input device is external to said mobile electronic device.

38. A system according to claim 37 wherein said mobile electronic device comprises a mobile communication device.

39. A system according to claim 38 wherein said mobile communication device comprises a cellular telephone.

40. A system according to claim 36 wherein said display area is integrally formed with a tablet and wherein said input device is external to said tablet.

41. A system according to claim 35 wherein said control data injection point comprises the finger-data injection point.

42. A system for accepting at least one keyboard input not supported by a touch-based operating system operative, responsive to touch inputs, to perform a plurality of operations, the system comprising:
a non-supported keyboard input processing functionality operative to receive an indication of said keyboard input and responsively to instruct said touch-based operating system to perform a subset of said plurality of operations.

43. A system according to claim 42 wherein said keyboard input includes a simultaneously pressed plurality of keys not supported by the touch-based operating system.

44. A system according to claim 42 wherein said keyboard input includes a single key not supported by the touch-based operating system.

45. A system according to claim 42 wherein said touch-based operating system comprises Android.

46. A system according to claim 42 and also comprising a touch-based operating system operative to perform said subset of operations responsive to touch inputs.

47. Browser apparatus operative in conjunction with an individual operating system, the browser apparatus comprising:
a self-identifier operative to send to a website, deceptive user agent information identifying at least one of:
an operating system other than said individual operating system; and
a browser other than said browser apparatus; and
a web content engine operative, in conjunction with the operating system, to receive web content from the website and to enable a human user to interact with the web content.

48. A system according to claim 47 and also comprising an operating system and wherein said deceptive user agent information is provided to said self-identifier by said operating system.

49. A system according to claim 48 wherein said operating system includes browser-identifying functionality and is operative to identify said browser apparatus and to provide to said self-identifier deceptive user agent information including an identification of a browser other than said browser apparatus as identified.

50. A system according to claim 49 wherein said browser-identifying functionality comprises a field in memory of said operating system storing an identification of said browser apparatus.

51. A system according to claim 47 wherein the self-identifier is determined by obtaining from the operating system an indication of at least one IO device currently connected to said operating system and subsequently including in said deceptive user agent information, information capable of eliciting from the website, content which aptly utilizes the IO device.

52. A method for using an operating system to highlight a hovered upon portion of a computerized display area, the method comprising:
identifying a location within the computerized display area over which a cursor is hovering;
identifying a focussable portion of said display area which includes said location; and
using the operating system's focus functionality to change at least one graphic characteristic of said focussable portion.

53. A method according to claim 52 wherein said operating system comprises a touch-based operating system.

54. A method according to claim 53 wherein said touch-based operating system comprises Android.

55. An improved operating system comprising:
a touch-based operating system other than Windows7 which, given an application running on the operating system, determines at least one dimension of a display area used to display outputs of the application as a function of a resolution parameter and a density parameter defined within the operating system; and
a display device adaptation functionality operative to receive an indication of a display device currently connected to said operating system and to modify at least one of said resolution parameter and density parameter accordingly.

56. A system according to claim 55 wherein said touch-based operating system comprises Android.

57. A system according to claim 35 wherein said input device comprises an individual one of the following input devices: trackball, touchpad, mouse and wherein said scrolling functionality comprises a wheel.

58. A system according to claim 1 which is operative for selecting text displayed on a display device having a text display area,
wherein said operating system includes a touch-based text selection functionality recognizing inputs,
the operating system being operative to selectably connect to an input device operative, responsive to user manipulation thereof, to point to locations within said text display area, the input device including a user interface accepting user manipulations; and
wherein said operating system also includes a user manipulation translater translating said user manipulations into inputs recognized by said touch-based text selection functionality which, when recognized, cause said touch-based text selection functionality to select said locations.

59. A computerized system according to claim 1 which is operative for providing a context-aware pointer to a computerized display area serving at least one Android application,
the operating system comprising an Android operating system operative to display a hierarchy of Android views generated pursuant to said Android application,
the operating system comprising:
an Android view interpreter identifying, at each point in time, at least one view feature characterizing at least one of said views; and
a context-aware cursor generator operative to generate, on said computerized display, a cursor having cursor characteristics which vary over time wherein, at a particular point in time, at least one of said cursor characteristics depends on said view feature identified at said particular point in time, for a location pointed to by said cursor at said point in time.

60. A system according to claim 1 which is operative for input-device mediated scrolling, without touching a display area which is controlled by a touch-based cellular telephone operating system, the operating system comprising:
a control data injection point to a display control functionality in the touch-based operating system, the functionality being operative to display only a display area-sized portion of an image which is larger than said display area, responsive to sensed finger motions supplied via a finger-data injection point; and
an input device-mediated scrolling interpreter operative, responsive to user manipulation of a scrolling functionality of the input device, to inject to said display control functionality via said control data injection point, an indication of a display area-sized portion of the image to be displayed on the display area.

61. A system according to claim 1 which is operative for input-device mediated scrolling, without touching a display area which is controlled by a touch-based Android operating system, the operating system comprising:
a control data injection point to a display control functionality in the touch-based Android operating system, the functionality being operative to display only a display area-sized portion of an image which is larger than said display area, responsive to sensed finger motions supplied via a finger-data injection point; and
an input device-mediated scrolling interpreter operative, responsive to user manipulation of a scrolling functionality of the input device, to inject to said display control functionality via said control data injection point, an indication of a display area-sized portion of the image to be displayed on the display area.

62. A system according to claim 1 wherein said operating system includes a touch-based operating system operative, responsive to touch inputs, to perform a plurality of operations, the computerized system being operative for accepting at least one keyboard input not supported by the touch-based operating system, and wherein the touch-based operating system comprises:
a non-supported keyboard input processing functionality operative to receive an indication of said keyboard input and responsively to instruct said touch-based operating system to perform a subset of said plurality of operations.

63. A system according to claim 1 and also comprising Browser apparatus operative in conjunction with the individual operating system, the browser apparatus comprising:
a self-identifier operative to send to a website, deceptive user agent information identifying at least one of:
an operating system other than said individual operating system; and
a browser other than said browser apparatus; and
a web content engine operative, in conjunction with the operating system, to receive web content from the website and to enable a human user to interact with the web content.

64. An improved operating system according to claim 1, wherein said operating system includes a touch-based operating system other than Windows7 which, given an application running on the operating system, determines at least one dimension of a display area used to display outputs of the application as a function of a resolution parameter and a density parameter defined within the operating system; and
wherein said operating system includes a display device adaptation functionality operative to receive an indication of a display device currently connected to said operating system and to modify at least one of said resolution parameter and density parameter accordingly.

65. A system according to claim 1 wherein the existing population of I/O devices includes a plurality of screen displays and wherein said operating system recognizes a single screen display resolution parameter pre-defined during manufacture,
and wherein said computerized system also comprises a resolution parameter modifier operative to dynamically obtain an individual resolution value characterizing an individual screen display from among the plurality of screen displays which has dynamically become connected to said operating system and to modify said pre-defined screen display resolution parameter to equal said individual resolution value.

66. A system according to claim 18 wherein said cursor-based input device is selected from among the following group: a mouse, a touchpad, a trackball.

67. A system according to claim 13 wherein said I/O device to which said operating system has been connected includes a large screen which is larger than required by said user interface and wherein said UI adapting functionality is operative to add at least one UI element when said large screen is found to be connected to the operating system in order to more fully utilize the large screen.

68. A system according to claim 67 wherein said UI element is selected from the following: a task bar; and a menu.

69. A system according to claim 13 wherein said I/O device to which said operating system has been connected includes an external device which does not house at least one physical button assumed by said mobile operating system to exist and having a function, and wherein said UI adapting functionality is operative to add to said user interface, at least one software button restoring at least a portion of said function.

70. A system according to claim 1 wherein said computerized system also comprises a density modifier operative to dynamically obtain an individual density value characterizing an individual screen display from among the plurality of screen displays which has dynamically become connected to said operating system and to modify display content intended for said individual screen display accordingly.

71. A system according to claim 1 wherein said computerized system also comprises a resolution modifier operative to dynamically obtain an individual screen resolution value characterizing an individual screen display from among the plurality of screen displays which has dynamically become connected to said operating system and to modify display content intended for said individual screen display accordingly.

72. A system according to claim 70 wherein said content includes at least one of an icon, text and image and said density modifier is operative to modify a scaling factor applied to at least one of said icon, text and image.

73. A system according to claim 65 wherein said value characterizing an individual screen display is received from the connected display.

74. A system according to claim 65 wherein said value characterizing an individual screen display is obtained from a local table according to the resolution coming from the connected display.

75. A system according to claim 70 wherein said value characterizing an individual screen display is received from the connected display.

76. A system according to claim 70 wherein said value characterizing an individual screen display is obtained from a local table according to the resolution coming from the connected display.

77. A system according to claim 71 wherein said value characterizing an individual screen display is received from the connected display.

78. A system according to claim 71 wherein said value characterizing an individual screen display is obtained from a local table according to the resolution coming from the connected display.

79. A system according to claim 36 wherein said display area is integrally formed with a mobile electronic device and wherein said input device is external to said mobile electronic device.

80. A system according to claim 36 wherein said control data injection point comprises the finger-data injection point.

81. A system according to claim 36 wherein said input device comprises an individual one of the following input devices: trackball, touchpad, mouse and wherein said scrolling functionality comprises a wheel.

82. A computer program product, comprising a computer usable medium having a computer readable program code embodied therein, said computer readable program code adapted to be executed to implement any of the methods shown and described herein.
